(19) United States
(12) Patent Application Publication
(10) Pub. No.: US 2016/0338114 A1
(43) Pub. Date: Nov. 17, 2016

(54) BASE STATION, WIRELESS COMMUNICATION SYSTEM, AND WIRELESS COMMUNICATION METHOD

(71) Applicant: FUJITSU LIMITED, Kawasaki-shi (JP)

(72) Inventor: Masatsugu SHIMIZU, Yokohama (JP)

(21) Appl. No.: 15/146,641

(22) Filed: May 4, 2016

(30) Foreign Application Priority Data
May 15, 2015 (JP) 2015-100251

(51) Int. Cl. H04W 74/08

(52) U.S. Cl. CPC H04W 74/0841

(57) ABSTRACT

A base station including: a processor configured to: detect a plurality of preamble timings in a received wireless signal, decode a message that is one of a first message and a second message in another received wireless signal, generate a replica of the decoded message, specify a plurality of message timings in the another received wireless signal that correspond to the plurality of preamble timings in the received wireless signal, specify one or more cancel timings from among the plurality of message timings, generate a specified signal by cancelling the generated replica from the another received wireless signal in the one or more cancel timings, and decode the other of the first message and the second message that has not been decoded based on the specified signal and one or more specified timings that are the plurality of message timings other than the one or more cancel timings.

### CROSS-REFERENCE TO RELATED APPLICATION

This application is based upon and claims the benefit of priority of the prior Japanese Patent Application No. 2015-100251, filed on May 15, 2015, the entire contents of which are incorporated herein by reference.

### FIELD

The embodiment discussed herein is related to a base station, a wireless communication system, and a wireless communication method.

### BACKGROUND

In the 3rd Generation Partnership Project (3 GPP) that is a standard body for a mobile communication system, a communication standard that is called “Long Term Evolution (LTE)” is established. In LTE, at the time of initial access to a base station (which is hereinafter referred to an “eNB” at some times) by a user terminal (which is hereinafter referred to “user equipment (UE)” at some times), a “random access procedure” is executed. Random access is hereinafter referred to as “RA” at some times.

FIG. 1 is a diagram illustrating one example of an RA procedure for a related technology. The RA procedure includes exchanging messages (each of which is hereinafter referred to as a “Msg” at some times) 1 to 4 between the UE and the eNB. That is, in the RA procedure, first, the UE transmits an RA preamble as the Msg 1 to the eNB. An identifier (ID) of the RA preamble is included in the RA preamble. The preamble and the identifier of the RA preamble are hereinafter referred to as a “PA” and a “PA-ID”, respectively, at some times. The PA-ID that is included in the RA preamble is randomly selected by the UE from among multiple PA-IDs (for example, 64 PA-IDs in LTE) that are prepared in advance and that are different from one another.

Subsequently, the eNB that receives and detects the RA preamble transmits an RA response to the RA preamble, as a Msg 2 to the UE. Included in the RA response are the PA-ID that is included in the RA preamble and information (which is hereinafter referred to as an “uplink (UL) grant” at some times) indicating an uplink resource that is allocated to the eNB for the purpose of transmission of a Msg 3 in uplink.

Subsequently, the UE that receives the RA response checks whether or not a PA-ID that is selected by the UE itself, more precisely, a PA-ID that is transmitted to the eNB in a state of being included in the RA preamble is included in the received RA response. When the PA-ID that is selected by the UE itself is included in the received RA response, the UE transmits the Msg 3 that includes an identifier that is able to be specified in a manner that is unique to the UE itself, that is, an identifier which is specific to the UE itself, as data, is transmitted to the eNB using the uplink resource that is indicated in the UL grant. The identifier that is specific to each UE is hereinafter referred to as a “UE-ID” at some times.

Subsequently, the eNB that receives the Msg 3 using the uplink resource that is indicated in the UL grant transmits contention resolution as a Msg 4 to the UE. The UE-ID that is detected by the eNB from the Msg 3 is included in the contention resolution.

Then, the UE that receives the contention resolution determines whether or not success in the RA takes place, based on contents of the contention resolution. When the UE-ID of the UE itself is included in the contention resolution, the UE determines that the success in the RA takes place. When the UE-ID of the UE itself is not included in the contention resolution, the UE determines that failure in the RA takes place. The UE that succeeds in the RA can start communication of user data with the eNB.

Japanese Laid-open Patent Publication Nos. 2003-209879, 10-093529, 08-237190, and 07-066768 are examples of the related art.

### SUMMARY

According to an aspect of the invention, a base station includes a memory, and a processor coupled to the memory and configured to: detect a plurality of preamble timings in a received wireless signal, the plurality of preamble timings including one or more first preamble timings and one or more second preamble timings, the one or more first preamble timings being one or more timings in which a first random access preamble transmitted from a first terminal is received by the base station via one or more first path, the one or more second preamble timings being one or more timings in which a second random access preamble transmitted from a second terminal is received by the base station via one or more second path, the first random access preamble and the second random access preamble being transmitted using a same resource, decode a message that is one of a first message and a second message in another received wireless signal, the first message being transmitted from the first terminal and being associated with the first random access preamble, the second message being transmitted from the second terminal and being associated with the second random access preamble, the first message and the second message being transmitting using another same resource, generate a replica of the decoded message, specify a plurality of message timings in the another received wireless signal that correspond to the plurality of preamble timings in the received wireless signal, specify one or more cancel timings from among the plurality of message timings in the another received wireless signal, the one or more cancel timings in the another received wireless signal corresponding to the one or more first preamble timings in the received wireless signal when the decoded message is the first message transmitted from the first terminal, the one or more cancel timings in the another received wireless signal corresponding to the one or more second preamble timings in the received wireless signal when the decoded message is the second message transmitted from the second terminal, generate a specified signal by cancelling the generated replica from the another received wireless signal in the one or more cancel timings, and decode the other of the first message and the second message that has not been decoded in the another received wireless signal based on the specified signal and one or more specified timings that are the plurality of message timings other than the one or more cancel timings.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating one example of an RA procedure for a related technology;

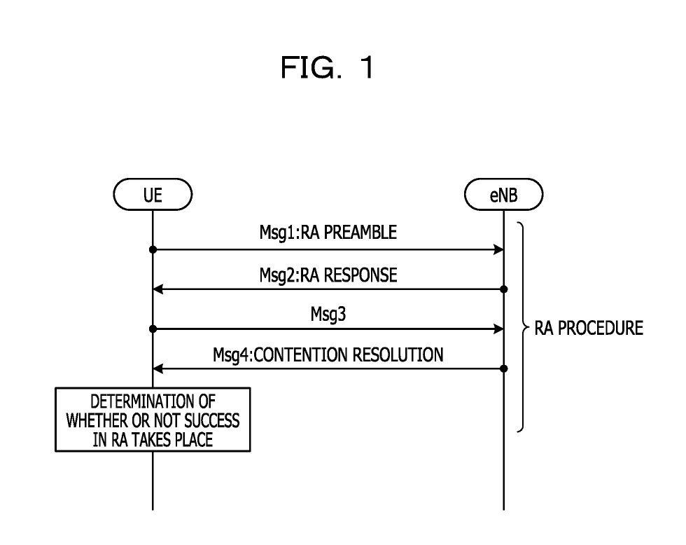

FIG. 2 is a diagram that serves to describe a problem;

FIG. 3 is a diagram illustrating one example of a configuration of a communication system according to a first embodiment;

FIG. 4 is a block diagram illustrating an example of a configuration of a base station according to the first embodiment;

FIG. 5 is a block diagram illustrating an example of a configuration of a user terminal according to the first embodiment;

FIG. 6 is a diagram that serves to describe an operational example of the base station according to the first embodiment;

FIG. 7 is a diagram that serves to describe the operational example of the base station according to the first embodiment;

FIG. 8 is a diagram that serves to describe the operational example of the base station according to the first embodiment;

FIG. 9 is a diagram that serves to describe the operational example of the base station according to the first embodiment;

FIG. 10 is a diagram that serves to describe the operational example of the base station according to the first embodiment;

FIG. 11 is a diagram that serves to describe the operational example of the base station according to the first embodiment;

FIG. 12 is a diagram that serves to describe the operational example of the base station according to the first embodiment;

FIG. 13 is a diagram that serves to describe an operational example of the base station according to the first embodiment;

FIG. 14 is a flowchart that serves to describe an example of processing by the base station according to the first embodiment;

FIG. 15 is a diagram illustrating one example of a sequence of processing by the communication system according to the first embodiment;

FIG. 16 is a diagram illustrating an example of a hardware configuration of the base station; and

FIG. 17 is a diagram illustrating a hardware configuration of the user terminal.

### DESCRIPTION OF EMBODIMENT

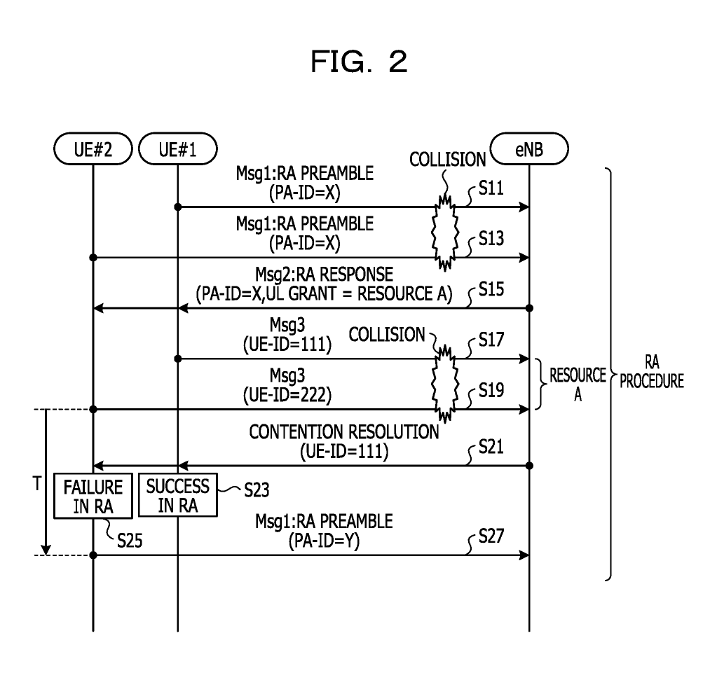

FIG. 2 is a diagram that serves to describe the problems. A case where two user terminals, that is, UE #1 and UE #2, perform RA on an eNB is described, as one example, referring to FIG. 2. Furthermore, FIG. 2 is one example of an RA procedure in a case where the UE #1 and the UE #2 transmit the same RA preamble to each other using the same resource.

In Step S11, the UE #1 randomly selects one PA-ID from among multiple PA-IDs that are prepared in advance and that are different from one another, and transmits a RA preamble that includes the selected PA-ID, as the Msg 1 to the eNB. In Step S11, the UE #1 is assumed to select PA-ID=X.

In Step S13, the UE #2 selects one PA-ID from among multiple PA-IDs that are prepared in advance and that are different from one another, and transmits the RA preamble that includes the selected PA-ID, as the Msg 1 to the eNB. In Step S13, the UE #2 is assumed to select PA-ID=X. More precisely, the UE #2 is assumed to select the same PA-ID as the PA-ID that is selected by the UE #1. Furthermore, the transmission of the RA preamble from the UE #2 is assumed to be performed using the same resource as with the transmission of the RA preamble from the UE #1.

Consequently, in the eNB, the PA-ID of the RA preamble that is received from the UE #1 in Step S11 and the PA-ID of the PA preamble that is received from the UE #2 in Step S13 are the same, that is, PA-ID=X. Furthermore, the transmission of the RA preamble from the UE #1 and the transmission of the RA preamble from the UE #2 are performed using the same resource. For this reason, in the eNB, the RA preamble that is received from the UE #1 and the RA preamble that is received from the UE #2 collide with each other, and the reception of the two RA preambles is measured as multiple-times reception of the same.

Accordingly, in Step S15, the eNB that detects the RA preamble that includes PA-ID=X transmits an RA response that includes PA-ID=X and UL grant=resource A, as the Msg 2. An uplink resource that is indicated by a UL grant is stipulated with time and a frequency.

In Step S17, because the PA-ID that is selected by the UE #1 itself, more precisely, PA-ID=X is included in the received RA response, the UE #1 transmits the Msg 3 that includes UE-ID=111, which is a UE-ID of the UE #1, as data, to the eNB, using a resource A.

In Step S19, because the PA-ID that is selected by the UE #2 itself, more precisely, PA-ID=X is included in the received RA response, the UE #2 transmits the Msg 3 that includes UE-ID=222, which is a UE-ID of the UE #2, as data, to the eNB, using the resource A.

Because the Msg 3 from the UE #1 and the Msg 3 from the UE #2 are both transmitted using the resource A, they reach the eNB in a temporarily overlapping manner. Consequently, in the eNB, the Msg 3 from the UE #1 and the Msg 3 from the UE #2 collide with each other. In this manner, in a case where the Msg 3 from the UE #1 and the Msg 3 from the UE #2 collide with each other in a temporarily overlapping manner, the Msg 3 from the UE #2 interferes with the Msg 3 from the UE #1, and the Msg 3 from the UE #1 interferers with the Msg 3 from the UE #2. For this reason, while the Msg 3 from the UE #1 and the Msg 3 from the UE #2 temporarily overlap each other in the eNB, it is possible for the eNB to detect only the Msg 3 from the UE that is in a favorable channel environment, among the UE #1 and the UE #2. For example, in a case where the UE #1 is in the favorable channel environment and the UE #2 is in a poor favorable channel environment, it is possible for the eNB to detect only the Msg 3 from the UE #1, and it is difficult for the eNB to detect the Msg 3 from the UE #2.

Consequently, in Step S21, the eNB detects UE-ID=111 from the Msg 3 from the UE #1 that is in the favorable channel environment, among the Msg 3 from the UE #1 and the Msg 3 from the UE #2 that are both received with the resource A. Then, the eNB transmits a contention resolution that includes UE-ID=111 which is detected.

In Step S23, because UE-ID=111, which is the UE-ID of the UE #1 itself, is included in the received contention resolution, the UE #1 that receives the contention resolution determines that the UE #1 succeeds in the RA.

On the other hand, in Step S25, because UE-ID=222 that is the UE-ID of the UE #2 itself is not included in the received contention resolution, the UE #2 that receives the contention resolution determines that the UE #2 fails in the RA.

Then, in Step S27, the UE #2 does not receive the contention resolution that includes UE-ID=222, and, when a prescribed time T has elapsed from when the Msg 3 is transmitted in Step S19, selects the PA-ID again and retransmits the RA preamble. In Step S27, the UE #2 is assumed to select PA-ID=Y. Consequently, the RA procedure is executed again on the UE #2.

As described above, in FIG. 2, the RA preamble that is received by the UE #1, and the RA preamble that is received by the UE #2 are the same. For this reason, when the transmission of the RA preamble from the UE #1 and the transmission of the RA preamble from the UE #2 are performed using the same resource, in the eNB, the RA preamble from the UE #1 and the RA preamble from the UE #2 collide with each other. Then, as a result of the collision of the RA preambles occurring, the Msg 3 from the UE #1 and the Msg 3 from the UE #2 collide with each other in eNB. As a result, the UE #2 in the poor channel environment fails in the RA, the RA procedure is repeatedly performed on the UE #2. With the repetitive execution of the RA procedure on the UE #2, a delay occurs in the execution of the RA procedure on the UE #2 and power consumption by the UE #2 and the eNB increases.

At this point, there is a limitation on the number of the PA-IDs that are selection candidates (for example, 64 PA-IDs are present in LTE). Thus, because the more the number of UE items increases, the higher the likelihood that the RA preambles will collide with each other becomes, and the higher the likelihood that the Msgs 3 will collide with each other becomes, the rate of the success in the RA decreases. Consequently, the more the number of UE items increases, the higher the likelihood that the delay time for the execution of the RA procedure will increase becomes and the higher the likelihood that the power consumption by the UE and the eNB will increase becomes.

An object of a technology in the present disclosure, which is contrived in view of what is described above, is to achieve an improvement in the rate of the success in the RA.

Embodiments of a base station, a communication terminal, and a communication system that are disclosed in the present application will be described referring to the drawings. Moreover, the embodiments do not impose any limitation on the base station, the communication terminal and the communication system that are disclosed in the present application. Furthermore, in each of the embodiments, constituent units that have the same function and steps of performing the same processing are given the same reference numerals and redundant descriptions thereof are omitted.

### First Embodiment

### Example of a Configuration of the Communication System

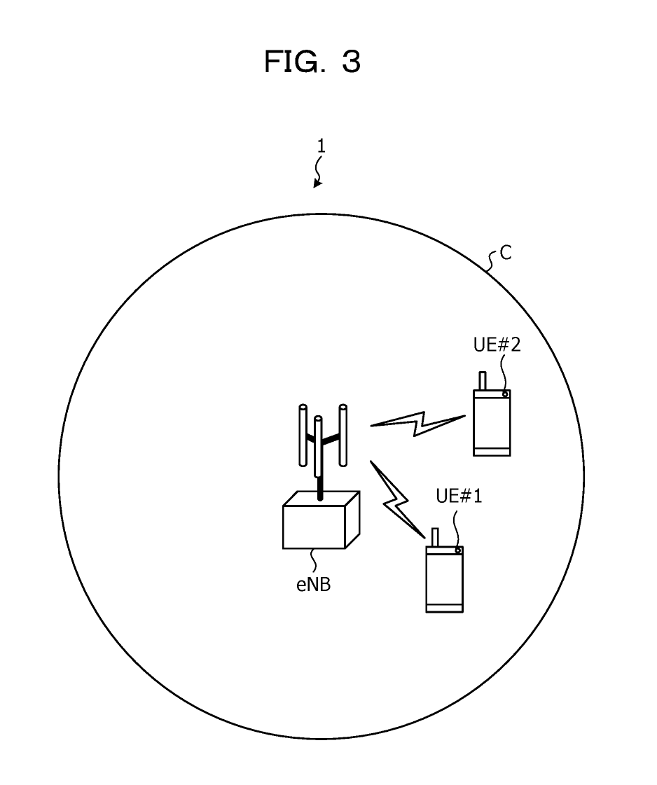

FIG. 3 is a diagram illustrating one example of a configuration of a communication system according to a first embodiment. In FIG. 3, a communication system 1 has the eNB, the UE #1 and the UE #2. The UE #1 and the UE #2 are user terminals that are different from each other. The eNB constitutes a cell C. The UE #1 and the UE #2 are positioned within the cell C. At the time of initial access to the eNB by the UE #1 and the UE #2, the RA procedure is executed. In the RA procedure, the UE #1 and the UE #2 transmits the RA preamble as the Msg 1 and the Msg 3 that includes the UE-ID as the data, to the eNB. The eNB transmits the RA response as the Msg 2 and the contention resolution as the Msg 4 to the UE #1 and the UE #2. In a case where the UE #1 and the UE #2 are not distinguished from each other, the UE #1 and the UE #2 are hereinafter collectively referred to as UE at some times.

For identification of each item of UE within the cell C, a “cell radio network temporary identifier (C-RNTI)” is used. The C-RNTI is an identifier dedicated for each item of UE within the cell C, and the number of bits for the C-RNTI is smaller than the number of bits for the UE-ID. Furthermore, in the RA procedure, a temporary C-RNTI (hereinafter referred to as a “TC-RNTI” at some times) that is temporally a virtual C-RNTI is used. The TC-RNTI is a temporal C-RNTI that is only in the RA procedure.

At this point, the UE is one example of the communication terminal. The communication terminals, for example, include not only mobile terminals, such as a portable telephone, a smartphone, and a tablet terminal, but also a machine type communication (MTC) terminal, such as a smart meter.

<Example of a Configuration of the Base Station>

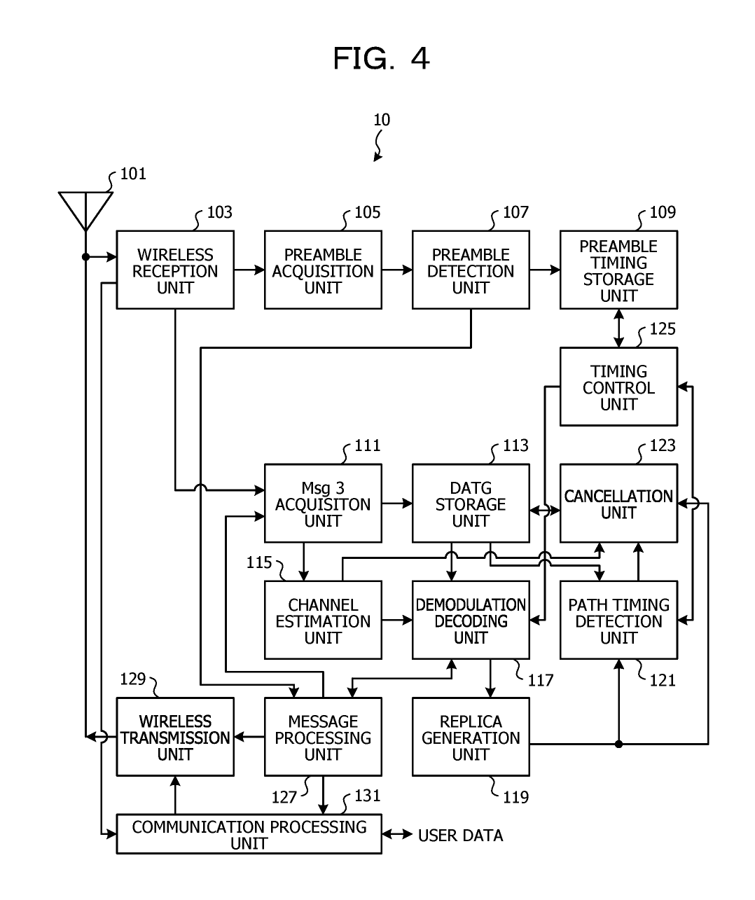

FIG. 4 is a block diagram illustrating an example of a configuration of a base station according to the first embodiment. A base station 10 that is illustrated in FIG. 4 is equivalent to the eNB that is illustrated in FIG. 3. As illustrated in FIG. 4, the base station 10 has an antenna 101, a wireless reception unit 103, a preamble acquisition unit 105, a preamble detection unit 107, a preamble timing storage unit 109, an Msg 3 acquisition unit 111, and a data storage unit 113. Furthermore, the base station 10 has a channel estimation unit 115, a demodulation decoding unit 117, a replica generation unit 119, a path timing detection unit 121, a cancellation unit 123, and a timing control unit 125. Furthermore, the base station 10 has a message processing unit 127, a wireless transmission unit 129, and a communication processing unit 131.

The wireless reception unit 103 performs wireless reception processing, such as down-conversion and analog-to-digital conversion, on a signal that is received from the UE through the antenna 101, and obtains a reception signal in a baseband. The wireless reception unit 103 outputs the reception signal to the preamble acquisition unit 105, the Msg 3 acquisition unit 111, and the communication processing unit 131.

The preamble acquisition unit 105 acquires the RA preamble from the reception signal in the baseband, and outputs the acquired RA preamble to the preamble detection unit 107. The RA preamble as the Msg 1 includes one PA-ID, among the multiple PA-IDs (for example, 64 PA-IDs in LTE) that are different from one another. The multiple PA-IDs correspond to multiple preamble sequences with the same sequence length, respectively, and the PA-ID is included in the RA preamble as a preamble sequence that corresponds to the PA-ID. As one example of the preamble sequence, there is a Zadoff-Chu sequence. The RA preamble is transmitted as the Msg 1 from the UE in the RA preamble.

The preamble detection unit 107 detects the PA-ID that is included in the RA preamble, and a path timing of the RA preamble. The path timing of the RA preamble is referred to as a “preamble timing” at some times. Furthermore, the preamble timing is referred to as a “PA timing” at some times. The preamble detection unit 107 outputs the detected PA-ID to the message processing unit 127, and outputs the PA timing that is detected for every PA-ID, to the preamble timing storage unit 109. The preamble detection unit 107, for example, calculates a value of correlation between the RA preamble that is input from the preamble acquisition unit 105, and each of the known preamble sequences (for example, 64 preamble sequences in LTE) that are different from one another for every PA-ID. Then, for example, when the value of the correlation that is equal to or greater than a threshold is obtained with the preamble sequence that is assumed as a target, the preamble detection unit 107 detects the PA-ID that corresponds to the preamble sequence that is assumed as the target, from the RA preamble. Furthermore, for example, the preamble detection unit 107 detects the timing at which the value of the correlation that is equal to or greater than the threshold is obtained with the preamble sequence by the preamble sequence that is assumed as the target, as the PA timing of the PA-ID that corresponds to the preamble sequence which is assumed as the target.

The preamble timing storage unit 109 stores the PA timing for every PA-ID.

The Msg 3 acquisition unit 111 acquires the Msg 3 from the reception signal in the baseband according to the UL grant that is input from the message processing unit 127, and outputs the acquired Msg 3 to the data storage unit 113. Furthermore, the Msg 3 acquisition unit 111 outputs a payload that is attached to the acquired Msg 3, to the channel estimation unit 115. In the RA procedure, the Msg 3 is one example of the data that is transmitted from the UE after the transmission of the RA preamble.

The channel estimation unit 115 calculates a channel estimation value using the payload that is input from the Msg 3 acquisition unit 111. The channel estimation unit 115 outputs the calculated channel estimation value to the demodulation decoding unit 117 and the cancellation unit 123.

The data storage unit 113 stores the Msg 3 that is input from the Msg 3 acquisition unit 111, and the data that undergoes cancellation processing in the cancellation unit 123. The Msg 3 that is input from the Msg 3 acquisition unit 111 and the data that undergoes the cancellation processing in the cancellation unit 123 are hereinafter collectively referred to as “demodulation-target data” at some times.

The demodulation decoding unit 117 demodulates the demodulation-target data that is stored in the data storage unit 113, according to timing control from the timing control unit 125. Furthermore, the demodulation decoding unit 117 decodes the post-demodulation data, and outputs the post-decoding data to the replica generation unit 119 and the message processing unit 127. The demodulation decoding unit 117 demodulates the demodulation-target data using the channel estimation value that is input from the channel estimation unit 115. Furthermore, the demodulation decoding unit 117 demodulates the demodulation-target data using the TC-RNTI that is input from the message processing unit 127.

The replica generation unit 119 codes and modulates the data that undergoes the decoding in the demodulation decoding unit 117, generates a replica of the Msg 3, and outputs the generated replica to the path timing detection unit 121 and the cancellation unit 123.

The path timing detection unit 121 detects a path timing (hereinafter referred to as a “cancellation timing” at some times) of the data (hereinafter referred to as “cancellation data” at some times) that is canceled from the received Msg 3. The path timing detection unit 121, for example, detects the cancellation timing according to the timing control from the timing control unit 125. The path timing detection unit 121 outputs the detected cancellation timing to the cancellation unit 123 and the timing control unit 125. The path timing detection unit 121, for example, calculates a value of correlation between the demodulation-target data that is stored in the data storage unit 113, and the replica that is generated in the replica generation unit 119, and detects the timing at which the value of the correlation that is equal to or greater than a threshold is obtained, as the cancellation timing.

Based on the cancellation timing that is detected in the path timing detection unit 121, the cancellation unit 123 performs the “cancellation processing” that cancels the cancellation data from the demodulation-target data that is stored in the data storage unit 113. The cancellation unit 123, for example, multiplies the replica that is generated in the replica generation unit 119, by the channel estimation value, and thus generates the cancellation data. Then, the cancellation unit 123 updates the demodulation-target data that is stored in the data storage unit 113, with the data that undergoes the cancellation processing.

The timing control unit 125 refers to the PA timing that is stored in the preamble timing storage unit 109. Furthermore, the timing control unit 125 updates the PA timing that is stored in the preamble timing storage unit 109, using the cancellation timing that is a target from the cancellation processing. Based on the PA timing that is stored in the preamble timing storage unit 109, the timing control unit 125 controls a demodulation timing in the demodulation decoding unit 117. Furthermore, based on the PA timing that is stored in the preamble timing storage unit 109, the timing control unit 125 controls a detection timing of the cancellation timing in the path timing detection unit 121.

The message processing unit 127 generates the Msg 2 and an Msg 4. Based on the PA-ID that is detected in the preamble detection unit 107, the message processing unit 127 generates the RA response as the Msg 2, and codes and modulates the generated RA response. The message processing unit 127 outputs the post-modulation RA response to the wireless transmission unit 129. Furthermore, the message processing unit 127 determines the UL grant for the Msg 3, and includes the determined UL grant in the RA response and outputs the determine UL grant to the Msg 3 acquisition unit 111. Furthermore, the message processing unit 127 includes the TC-RNTI that corresponds to the determined UL grant, in the RA response. Furthermore, based on the data that undergoes the decoding in the demodulation decoding unit 117, the message processing unit 127 generates the contention resolution as the Msg 4, and codes and modulates the generated contention resolution. The message processing unit 127 outputs the post-modulation contention resolution to the wireless transmission unit 129. Furthermore, the message processing unit 127 outputs the TC-RNTI that corresponds to the determined UL grant to the demodulation decoding unit 117. Furthermore, the message processing unit 127 allocates the C-RNTI to each item of UE, and outputs the allocated C-RNTI to the communication processing unit 131.

The communication processing unit 131 acquires user data from the reception data in the baseband, demodulates and decodes the acquired user data using the C-RNTI, and outputs the post-decoding user data. Furthermore, the communication processing unit 131 codes and modulates transmission-target user data using the C-RNTI, and outputs the post-modulation user data to the wireless transmission unit 129.

The wireless transmission unit 129 performs wireless transmission processing, such as digital-to-analog conversion and up-conversion, on the post-modulation RA response, the post-modulation contention resolution, and the post-modulation user data, and thus obtains a wireless signal. The wireless transmission unit 129 transmits the wireless signal through the antenna 101.

<Example of a User Terminal>

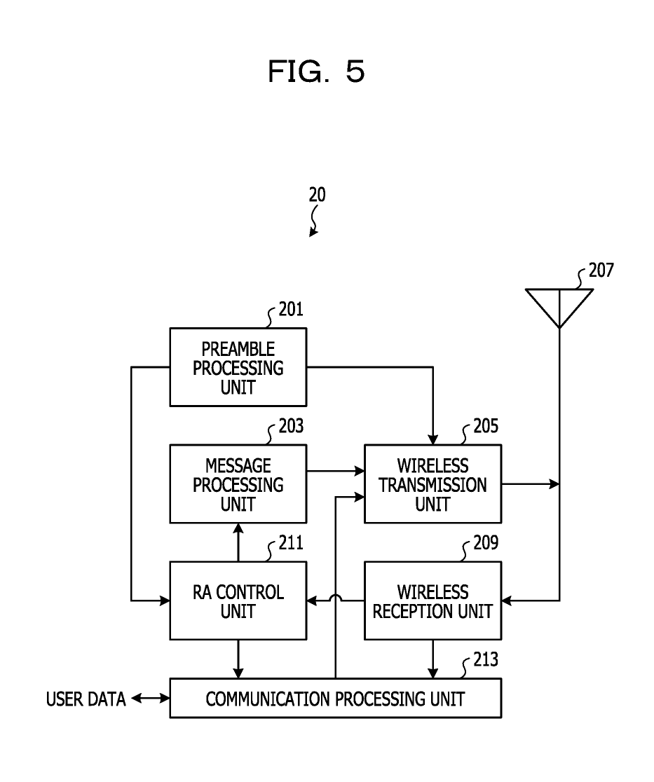

FIG. 5 is a block diagram illustrating an example of a configuration of a user terminal according to the first embodiment. The user terminal 20 that is illustrated in FIG. 5 is equivalent to the UE #1 and the UE #2 that are illustrated in FIG. 3. As illustrated in FIG. 5, the user terminal 20 has a preamble processing unit 201, a message processing unit 203, a wireless transmission unit 205, and an antenna 207. Furthermore, the user terminal 20 has a wireless reception unit 209, a RA control unit 211, and a communication processing unit 213.

The preamble processing unit 201 randomly selects one PA-ID from among the multiple PA-IDs (for example, 64 PA-IDs in LTE) that are prepared in advance and that are different from one another, and generates the RA preamble that includes the selected PA-ID. The multiple PA-IDs correspond to the multiple preamble sequences with the same sequence length, respectively, and the preamble processing unit 201 includes a preamble sequence that corresponds to the selected PA-ID, in the RA preamble. The preamble processing unit 201 outputs the generated RA preamble as the Msg 1 to the wireless transmission unit 205. Furthermore, the preamble processing unit 201 outputs the selected PA-ID to the RA control unit 211.

The message processing unit 203 generates the Msg 3. The message processing unit 203 codes and modulates the Msg 3 that includes the UE-ID, using the TC-RNTI that is input from the RA control unit 211. The message processing unit 203 maps the post-modulation Msg 3 to the uplink resource that is indicated in the UL grant which is input from the RA control unit 211, and outputs the post-mapping Msg 3 to the wireless transmission unit 205.

The wireless reception unit 209 performs the wireless reception processing, such as the down-conversion and the analog-to-digital conversion, on the signal that is received from the base station 10 through the antenna 207, and obtains the reception signal in the baseband. The wireless reception unit 209 outputs the reception signal in the base to the RA control unit 211 and the communication processing unit 213.

The RA control unit 211 acquires the RA response from the reception signal in the base band. The PA-ID, the TC-RNTI, and the UL grant are included in the RA response. The RA control unit 211 acquires the PA-ID, the TC-RNTI and the UL grant from the RA response. The RA control unit 211 determines whether or not the PA-ID that is input from the preamble processing unit 201 and the PA-ID that is acquired from the RA response are consistent with each other. The RA control unit 211 outputs the TC-RNTI and the UL grant that are acquired from the RA response, to the message processing unit 203. Furthermore, the RA control unit 211 acquires the c contention resolution from the reception signal in the baseband. The UE-ID and the C-RNTI are included in the contention resolution. The RA control unit 211 acquires the UE-ID and the C-RNTI from the contention resolution. The RA control unit 211 determines the success and the failure in the RA based on the UE-ID that is acquired from the contention resolution. When it is determined that the success in the RA takes place, the RA control unit 211 outputs the C-RNTI that is acquired from the contention resolution, to the communication processing unit 213.

The communication processing unit 213 acquires the user data from the reception data in the baseband, demodulates and decodes the acquired user data using the C-RNTI, and outputs the post-decoding user data. Furthermore, the communication processing unit 213 codes and modulates the transmission-target user data using the C-RNTI, and outputs the post-modulation user data to the wireless transmission unit 205.

The wireless transmission unit 205 performs the wireless transmission processing, such as the digital-to-analog conversion and the up-conversion, on the RA preamble, the post-modulation Msg 3, and the post-modulation user data, and thus obtains the wireless signal. The wireless transmission unit 205 transmits the wireless signal through the antenna 207.

<Operational Examples of the Base Station and the User Terminal>

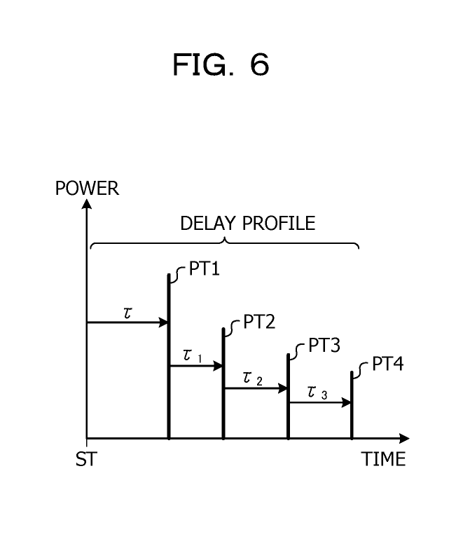

FIGS. 6 to 13 are diagrams that serve to describe an operational example of the base station according to the first embodiment. As one example, a case in which the RA preamble and the Msg 3 from the UE #1 reach the base station 10 through two paths and in which the RA preamble and the Msg 3 from the UE #2 reach the base station 10 through two paths that are different from the two paths through which the RA preamble and the Msg 3 from the UE #1 reach the base station 10 will be described below. The UE #1 and the UE #2 that are mentioned in an operational example that will be described below are equivalent to the user terminals 20 that are illustrated in FIG. 5.

In the UE #1, the preamble processing unit 201 selects, for example, PA-ID=X from among the multiple PA-IDs that are prepared in advance and that are different from one another, and the wireless transmission unit 205 transmits the RA preamble that includes PA-ID=X, as the Msg 1, to the base station 10. The RA preamble from the UE #1 reaches the base station 10 through two paths, that is, a path 1 and a path 2. Furthermore, in the UE #1, the preamble processing unit 201 outputs PA-ID=X to the RA control unit 211.

In the UE #2, for example, PA-ID=X is selected from among the multiple PA-IDs that are prepared in advance and that are different from one another, and the wireless transmission unit 205 transmits the RA preamble that includes PA-ID=X, as the Msg 1, to the base station 10. Furthermore, in the UE #2, the preamble processing unit 201 outputs PA-ID=X to the RA control unit 211. At this point, the UE #2 is assumed to transmit the RA preamble on the same resource as the resource on which the UE #1 transmits the RA preamble. More precisely, the UE #1 and the UE #2 are assumed to transmit the same RA preamble to each other using the same resource. The RA preamble from the UE #2 reaches the base station 10 through two paths, that is, a path 3 and a path 4. Consequently, the base station 10 receives the four RA preambles, which are transmitted on the same resource from the UE #1 and the UE #2, through four paths, that is, the path 1, the path 2, the path 3, and the path 4 that are different from one another.

The preamble detection unit 107 detects the PA-ID that is included in the RA preamble. Because the PA-IDs of the received four RA preambles are all Xs that are the same, the preamble detection unit 107 detects PA-ID=X from the four RA preambles. Because the PA-ID that is detected four times is the same X at all times, the preamble detection unit 107 outputs PA-ID=X to the message processing unit 127 only one time, even though the PA-ID is detected four-times.

Furthermore, for example, the preamble detection unit 107 detects four PA timings PT1, PT2, PT3, and PT4 that are illustrated in FIG. 6, and acquires a delay profile that is illustrated in FIG. 6. The PA timing PT1 is the path timing of the RA preamble that is received in the base station 10 from the UE #1 through the UE #1. The PA timing PT2 is the path timing of the RA preamble that is received in the base station 10 from the UE #1 through the UE #2. The PA timing PT3 is the path timing of the RA preamble that is received in the base station 10 from the UE #2 through the UE #3. The PA timing PT4 is the path timing of the RA preamble that is received in the base station 10 from the UE #2 through the UE #4. More precisely, the PA timings PT1 and PT2 are one example of the PA timing of the UE #1, and the PA timings PT3 and PT4 are one example of the PA timing of the UE #2. For example, the PA timing PT1 is delayed by as much as τ from a reference timing ST of the base station 10, and the PA timing PT2 is delayed by as much as τ1 from the PA timing PT1. For example, the PA timing PT3 is delayed by as much as τ2 from the PA timing PT2, and the PA timing PT4 is delayed by as much as τ3 from the PA timing PT3.

In this manner, because in the base station 10, the PA-IDs of the received four RA preambles are the same Xs, the PA timings PT1, PT2, PT3, and PT4 are observed as timings of a multi path of the same RA preamble. That is, the PA timing PT1 is equivalent to a preceding wave, the PA timing PT2 is equivalent to a first delay wave, the PA timing PT3 is a second delay wave, and the PA timing PT4 is equivalent to a third delay wave.

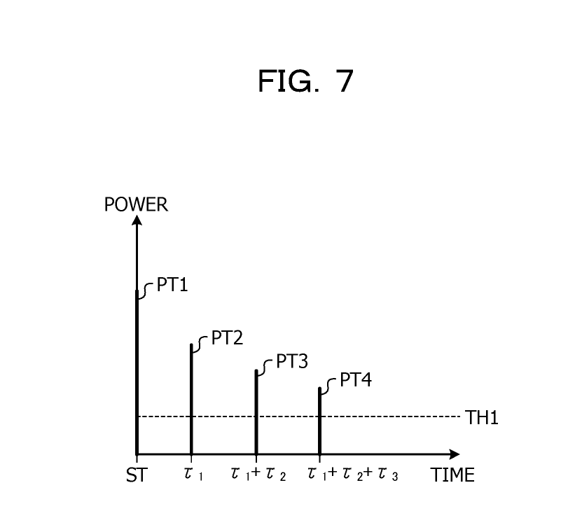

The preamble detection unit 107 outputs the delay τ to the message processing unit 127. Furthermore, the preamble detection unit 107 shifts the delay profile, which is illustrated in FIG. 6, by as much as −τ, and outputs the post-shift delay profile to the preamble timing storage unit 109. The delay profile that is illustrated in FIG. 6 is shifted by as much as τ, and thus as illustrated in FIG. 7, the PA timing PT1 is consistent with the reference timing ST of the base station 10. Consequently, the PA timings PT1, PT2, PT3, and PT4 that are illustrated in FIG. 7 are stored in the preamble timing storage unit 109. In the preamble timing storage unit 109, the PA timing PT1 is a timing that is not delayed from the reference timing ST, and the PA timing PT2 is a timing that is delayed by as much as τ₁ from the reference timing ST. Furthermore, in the preamble timing storage unit 109, the PA timing PT3 is a timing that is delayed by as much as τ₁+τ₂ from the reference timing ST, and the PA timing PT4 is a timing that is delayed by as much as τ₁+τ₂+τ₃ from the reference timing ST.

In this manner, the preamble detection unit 107 detects the respective PA timings PT1, PT2, PT3, and PT4 of the same multiple RA preambles that are transmitted from both of the UE #1 and the UE #2 in the RA procedure.

Subsequently, when PA-ID=X and the delay τ are input from the preamble detection unit 107, the message processing unit 127 determines the UL grant for the Msg 3. The message processing unit 127, for example, determines the UL grant as the release A. Then, the message processing unit 127 generates the RA response that includes PA-ID=X, a transmission timing compensation value τ that is equivalent to the delay τ, UL grant=resource A, and the TC-RNTI (for example, TC-RNTI=01) that corresponds to the resource A. The generated RA response is transmitted, as the Msg 2 in the RA procedure, by the wireless transmission unit 129 through the antenna 101. Furthermore, the message processing unit 127 outputs UL grant=resource A that is determined, to the Msg 3 acquisition unit 111, and outputs TC-RNTI=01 to the demodulation decoding unit 117.

Subsequently, in the RA control unit 211 of the UE #1, PA-ID=X that is input from the preamble processing unit 201 and PA-ID=X that is acquired from the RA response are consistent with each other. For this reason, in the UE #1, the RA control unit 211 acquires the transmission timing compensation value T, UL grant=resource A, and TC-RNTI=01, from the RA response. The RA control unit 211 of the UE #1 outputs the transmission timing compensation value T, UL grant=resource A, and TC-RNTI=01 to the message processing unit 203, and stores TC-RNTI=01. The message processing unit 203 of the UE #1 generates the Msg 3 that includes UE-ID=111 which is the UE-ID of the UE #1, in a data portion thereof. In the generation of the Msg 3, the message processing unit 203 of the UE #1 attaches a cyclic redundancy check (CRC) that is masked with TC-RNTI=01, to the data portion of the Msg 3. Then, the message processing unit 203 of the UE #1 codes the Msg 3 that includes the data portion which includes UE-ID=111 and the CRC bit which is masked with TC-RNTI=01. The message processing unit 203 of the UE #1 maps the post-coding Msg 3 to the resource A, and advances a transmission timing by as much as τ (more precisely, adjusts the transmission timing by as much as −τ). The Msg 3 that undergoes the mapping and the transmission timing adjustment is transmitted by the wireless transmission unit 205 of the UE #1 to the base station 10 through the antenna 207.

Furthermore, in the RA control unit 211 of the UE #2, PA-ID=X that is input from the preamble processing unit 201 and PA-ID=X that is acquired from the RA response are consistent with each other. For this reason, in the UE #2, the RA control unit 211 acquires the transmission timing compensation value τ, UL grant=resource A, and TC-RNTI=01, from the RA response. The RA control unit 211 of the UE #2 outputs the transmission timing compensation value τ, UL grant=resource A, and TC-RNTI=01 to the message processing unit 203, and stores TC-RNTI=01. The message processing unit 203 of the UE #2 generates the Msg 3 that includes UE-ID=222 which is the UE-ID of the UE #2, in the data portion thereof. In the generation of the Msg 3, the message processing unit 203 of the UE #2 attaches the CRC that is masked with TC-RNTI=01, to the data portion of the Msg 3. Then, the message processing unit 203 of the UE #2 codes the Msg 3 that includes the data portion which includes UE-ID=222 and the CRC bit which is masked with TC-RNTI=01. The message processing unit 203 of the UE #2 maps the post-coding Msg 3 to the resource A, and advances a transmission timing by as much as τ (more precisely, adjusts the transmission timing by as much as −τ). The Msg 3 that undergoes the mapping and the transmission timing adjustment is transmitted by the wireless transmission unit 205 of the UE #2 to the base station 10 through the antenna 207.

Subsequently, in the base station 10, the Msg 3 acquisition unit 111 acquires the Msg 3 according to UL grant=resource A that is input from the message processing unit 127 and outputs the acquired Msg 3 to the data storage unit 113. Furthermore, the Msg 3 acquisition unit 111 outputs the payload that is attached to the acquired Msg 3, to the channel estimation unit 115.

At this point, because a time from the transmission of the RA preamble to the transmission of the Msg 3 is short, the Msg 3 is transmitted to the base station 10 through the same path as the path through which the RA preamble is transmitted. More precisely, the Msg 3 from the UE #1 reaches the base station 10 through the two paths, that is, t the path 1 and the path 2, and the Msg 3 from the UE #2 reaches the base station 10 through the two paths, that is, the path 3 and the path 4. Furthermore, both of the UE #1 and the UE #2 also transmit the Msg 3 using the same resource A. Consequently, the base station 10 receives the four Msgs 3 that are transmitted on the same resource from the UE #1 and the UE #2, and that are transmitted through the four paths, that is, the path 1, the path 2, the path 3, and the path 4, respectively, that are different from one another.

In a case where the delay τ₁+τ₂ is less than a time length of the Msg 3, the Msg 3 that is transmitted through the path 1 and the Msg 3 that is transmitted through the path 3 reach the eNB in a temporarily overlapping manner. Furthermore, in a case where the delay τ₁+τ₂+τ₃ is less than the time length of the Msg 3, the Msg 3 that is transmitted through the path 1 and the Msg 3 that is transmitted through the path 4 reach the eNB in a temporarily overlapping manner. Furthermore, in a case where the delay τ₂ is less than the time length of the Msg 3, the Msg 3 that is transmitted through the path 2 and the Msg 3 that is transmitted through the path 3 reach the eNB in a temporarily overlapping manner. Furthermore, in a case where the delay τ₂+τ₃ is less than the time length of the Msg 3, the Msg 3 that is transmitted through the path 2 and the Msg 3 that is transmitted through the path 4 reach the eNB in a temporarily overlapping manner. More precisely, in a case where any one of the delay τ₂, the delay τ₁+τ₂, the delay τ₂+τ₃, and the delay τ₁+τ₂+τ₃ is less than the time length of the Msg 3, the Msg 3 from the UE #1 and the Msg 3 from the UE #2 collide with each other in the base station 10. More precisely, the Msg 3 from the UE #1 and the Msg 3 from the UE #2 are included in the Msg 3 that is received by the wireless reception unit 103 of the base station 10, and the wireless reception unit 103 outputs a reception Msg 3 that includes the Msg 3 from the UE #1 and the Msg 3 from the UE #2, to the Msg 3 acquisition unit 111.

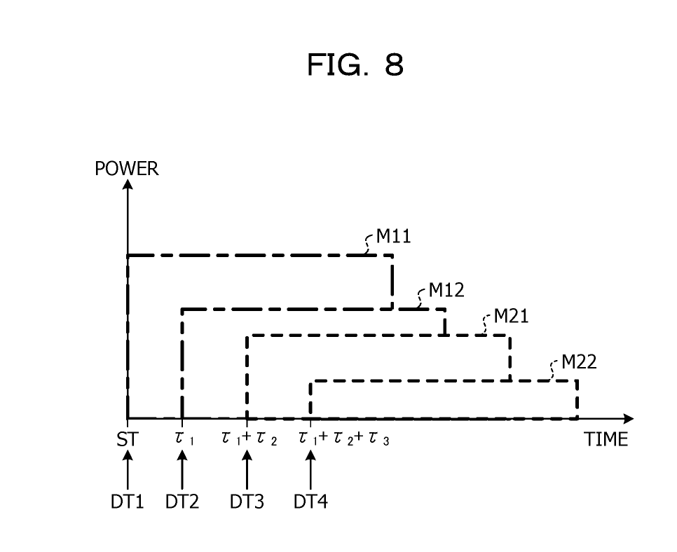

Consequently, for example, a state of the Msg 3 that is acquired by the Msg 3 acquisition unit 111 is as illustrated in FIG. 8. In FIG. 8, a “message M11” is the Msg 3 that is received from the UE #1 through the path 1, and a “message M12” is the Msg 3 that is received from the UE #1 through the path 2. Furthermore, a “message M21” is the Msg 3 that is received from the UE #2 through the path 3, and a “message M22” is the Msg 3 that is received from the UE #2 through the path 4. Consequently, contents of the message M11 and contents of the message M12 are the same, and contents of the message M21 and contents of the message M22 are the same. Furthermore, according to the transmission timing compensation value τ, the transmission timing of the Msg 3 is adjusted in the UE #1 and the UE #2. For this reason, in the base station 10, as illustrated in FIG. 8, a head timing DT1 (more precisely, the path timing of the message M11) of the message M11 is consistent with the reference timing ST of the base station 10. Furthermore, as described above, the Msg 3 is received in the base station 10 through the same path as the path through which the RA preamble is transmitted. For this reason, as illustrated in FIG. 8, the head timing DT2 (more precisely, the path timing of the message M12) of the message M12 is delayed by as much as τ₁ from the head timing DT1 of the message M11. Furthermore, a head timing DT3 (more precisely, the path timing of the message M21) of the message M21 is delayed by as much as τ₂ from the head timing DT2 of the message M12. Furthermore, a head timing DT4 (more precisely, the path timing of the message M22) of the message M22 is delayed by as much as T3 from the head timing DT3 of the message M21. Consequently, the head timing DT1 is consistent with the PA timing PT1, and the head timing DT2 is consistent with the PA timing PT2. Furthermore, the head timing DT3 is consistent with the PA timing PT3, and the head timing DT4 is consistent with the PA timing PT4. More precisely, the head timings of messages (namely, message timings) DT1, DT2, DT3, and DT4 (FIG. 8) correspond to the PA timings PT1, PT2, PT3, and PT4 (FIG. 7), respectively, on a one-to-one basis.

Furthermore, the Msg 3 that is acquired by the Msg 3 acquisition unit 111 includes the message M11, the message M12, the message M21, and the message M22, and these messages collide with one another. In the RA procedure, the Msg 3 that includes the messages M11, M12, M21, and M22 is one example of data that is received after the RA preamble is received by the base station 10.

Furthermore, at this point, as one example, it is assumed that a channel environment of the path 1 is better than a channel environment of the path 2, the channel environment of the path 2 is better than a channel of the path 3, the channel environment of the path 3 is better than a channel environment of the path 4. Consequently, reception power for the message M11 is greater than reception power for the message M12, and the reception power for the message M12 is greater than reception power for the message M21. More precisely, the reception power for the message M11 is sufficiently greater than reception power for the messages M21 and M22.

The data storage unit 113 stores the Msg 3 that includes the messages M11, M12, M21, and M22, as the demodulation-target data.

Consequently, the channel estimation unit 115 calculates a channel estimation value h₁ of the path 1 using the payload that is attached to the message M11, and calculates a channel estimation value h₂ of the path 2 using a payload that is attached to the message M12. Furthermore, the channel estimation unit 115 calculates a channel estimation value h₃ of the path 3 using the payload that is attached to the message M21, and calculates a channel estimation value h₄ of the path 4 using a payload that is attached to the message M22. The channel estimation unit 115 outputs the calculated channel estimation values h₁, h₂, h₃, and h₄ to the cancellation unit 123 and the demodulation decoding unit 117.

Subsequently, the timing control unit 125 outputs an instruction to perform demodulation, to the demodulation decoding unit 117 at the reference timing ST. According to the instruction to perform the demodulation, the demodulation decoding unit 117 demodulates the demodulation-target data that is stored in the data storage unit 113, more precisely, the demodulation-target data (FIG. 8) that includes the messages M11, M12, M21, and M22, at the reference timing ST that is set as the demodulation timing. At this time, the demodulation decoding unit 117 demodulates the demodulation-target data (FIG. 8) using the channel estimation value h₁. The post-demodulation message M11 is obtained with the demodulation at the reference timing ST. The demodulation decoding unit 117 decodes the post-demodulation message M11. The demodulation decoding unit 117 demasks the CRC bit, which is included in the post-decoding message M11, with TC-RNTI=01, and thus performs CRC. Because the CRC bit of the message M11, as described above, is demasked with TC-RNTI=01 by the UE #1, the demodulation decoding unit 117 succeeds in the CRC that results from the demasking that uses TC-RNTI=01. Consequently, the demodulation decoding unit 117 succeeds in decoding the message M11, and detects UE-ID=111 from a data portion of the message M11. The demodulation decoding unit 117 outputs the post-coding message M11 to the replica generation unit 119, and outputs UE-ID=111, which is detected, to the message processing unit 127.

Subsequently, when UE-ID=111 is input from the demodulation decoding unit 117, the message processing unit 127 generates the contention resolution that includes UE-ID=111 and the C-RNTI in a data portion thereof. In the generation of the contention resolution, the message processing unit 127 allocates, for example, C-RNTI=01, to UE-ID=111. The message processing unit 127 attaches the CRC bit that is masked with TC-RNTI=01, to the data portion of the contention resolution. Then, the message processing unit 127 codes the contention resolution that includes the data portion that includes UE-ID=111 and C-RNTI=01, and the CRC bit which is masked with TC-RNTI=01. The post-coding contention resolution is transmitted, as the Msg 4 in the RA procedure, by the wireless transmission unit 129, through the antenna 101. Furthermore, the message processing unit 127 outputs C-RNTI=01, which is allocated, to the communication processing unit 131.

Subsequently, the RA control unit 211 of UE #1 demodulates and decodes the contention resolution. The RA control unit 211 of the UE #1 demasks the CRC bit, which is included in the post-decoding contention resolution, with TC-RNTI=01, and thus performs the CRC. Because the CRC bit of the contention resolution, as described above, is masked with TC-RNTI=01 by the base station 10, the RA control unit 211 of the UE #1 succeeds in the CRC that results from the demasking that uses TC-RNTI=01. Consequently, the RA control unit 211 of the UE #1 succeeds in the decoding of the contention resolution, and detects UE-ID=111 and C-RNTI=01 from the data portion of the contention resolution. Because UE-ID that is acquired from the contention resolution and UE-ID=111 that is included in the Msg 3 are consistent with each other, the RA control unit 211 of the UE #1 determines that the success in the RA takes place. Furthermore, because the success in the RA takes place, the RA control unit 211 of the UE #1 outputs C-RNTI=01, which is included in the contention resolution, to the communication processing unit 213.

Then, the communication processing unit 213 of the UE #1 starts communication of the user data that uses C-RNTI=01 between the UE #1 and the base station 10. In the base station 10, the communication processing unit 131 starts the communication of the user data that uses C-RNTI=01, between the base station 10 and the UE #1. The communication processing unit 213 of the UE #1 attaches the CRC bit, which is masked with C-RNTI=01, to the user data that is a transmission target, codes the user data that undergoes the attaching of the CRC bit, and outputs the post-coding user data to the wireless transmission unit 205. In contrast, the communication processing unit 131 of the base station 10 demodulates and decodes the user data and demasks the CRC bit, which is attached to the post-coding user data, with C-RNTI=01, and thus performs the CRC. The communication processing unit 131 of the base station 10 attaches the CRC bit, which is masked with C-RNTI=01, to the user data that is a transmission target, codes the user data that undergoes the attaching of the CRC bit, and outputs the post-coding user data to the wireless transmission unit 129. In contrast, the communication processing unit 213 of the UE #1 demodulates and decodes the user data and demasks the CRC bit, which is attached to the post-coding user data, with C-RNTI=01, and thus performs the CRC.

On the other hand, in the base station 10, the replica generation unit 119 codes and modulates the post-coding message M11, generates a replica R11 of the message M11, and outputs the generated replica R11 to the path timing detection unit 121 and the cancellation unit 123.

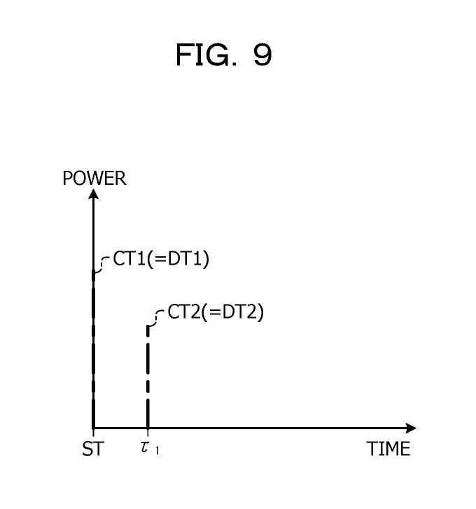

Subsequently, the path timing detection unit 121 calculates a value of correlation between the demodulation-target data that is stored in the data storage unit 113, more precisely, the demodulation-target data (FIG. 8) that includes the messages M11, M12, M21, and M22, and the replica R11. The replica R11 is a replica of the message M11. Furthermore, contents of the message M11 and contents of the message M12 are the same. Consequently, the value of the correlation between the demodulation-target data (FIG. 8) that includes the messages M11, M12, M21, and M22, and the replica R11 is equal to or greater than a threshold. Thus, the head timing DT1 of the message M11 and the head timing DT2 of the message M12 are available. Accordingly, the path timing detection unit 121, as illustrated FIG. 9, detects the head timing DT1 as a cancellation timing CT1, and detects the head timing DT2 as a cancellation timing CT2. The path timing detection unit 121 outputs the detected cancellation timings CT1 and CT2 to the cancellation unit 123.

At this point, for example, the path timing detection unit 121 detects the cancellation timing according to the timing control from the timing control unit 125.

For example, the timing control unit 125 outputs an instruction that calculates a correlation value at each of the four PA timings PT1 to PT4 (FIG. 7) which are stored in the preamble timing storage unit 109, to the path timing detection unit 121. According to the instruction that calculates the value of the correlation, the path timing detection unit 121 calculates the value of the correlation between the demodulation-target data and the replica R11 at each of the PA timings PT1 to PT4.

Furthermore, for example, the timing control unit 125 outputs the instruction that calculates the value of the correlation at the timing at which power is equal to or greater than a threshold TH1, among the four PA timings PT1 to PT4 (FIG. 7) that are stored in the preamble timing storage unit 109, to the path timing detection unit 121. According to the instruction that calculates the value of the correlation, the path timing detection unit 121 calculates the value of the correlation between the demodulation-target data and the replica R11 only at the timing at which the power is equal to or greater than the threshold TH1, among the PA timings PT1 to PT4.

Moreover, there is a likelihood that a state of the path through which the Msg 3 is transmitted will change by a change in the channel environment, high-speed movement of the UE, or the like during a period of time from a point in time at which the RA preamble is transmitted to a point in time at which the Msg 3 is transmitted, and thus that a path timing of the Msg 3 will change. For example, there is a likelihood that the head timing DT1 of the message M11 will be delayed by as much as τₐ (τₐ>τ) from the reference timing ST of the base station 10 while the PA timing PT1 is delayed by as much as τ from the reference timing ST of the base station 10. Conversely, there is also a likelihood that the head timing DT1 of the message M11 will be delayed by as much as τ_{b}(τ_{b}<τ) from the reference timing ST of the base station 10. Accordingly, the timing control unit 125 may output an instruction that calculates a value of correlation not only at each PA timing that is stored in the preamble timing storage unit 109, but also at a timing that falls within a fixed range of a deviation of plus and minus Δt from each PA timing, to the path timing detection unit 121. Consequently, for example, the path timing detection unit 121 calculates the value of the correlation between the demodulation-target data and the replica R11 at the timing that falls within the fixed range of the deviation of ±Δt from each of the PA timings PT1 to PT4.

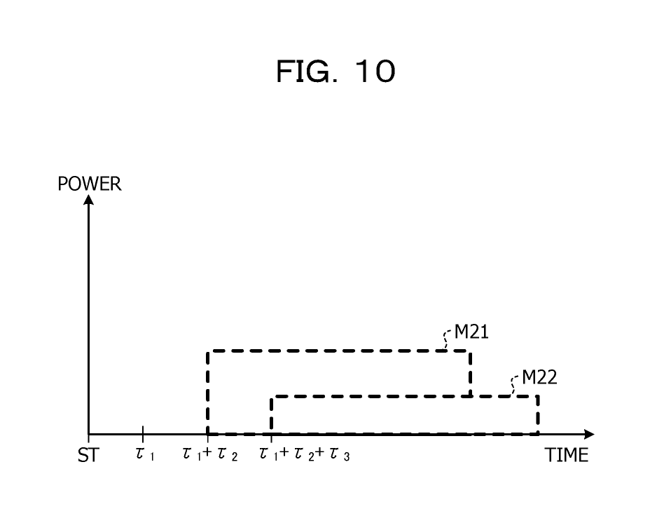

Subsequently, the cancellation unit 123 generates cancellation data CD11 by multiplying the replica R11 by the channel estimation value h₁, and generates cancellation data CD12 by multiplying the replica R11 by the channel estimation value h₂. Then, the cancellation unit 123 cancels the cancellation data CD11 and the cancellation data CD12 from the demodulation-target data that is stored in the data storage unit 113, more precisely, from the demodulation-target data (FIG. 8) that includes the messages M11, M12, M21, and M22. The cancellation unit 123 performs the cancellation processing with the cancellation data CD11 at the cancellation timing CT1, and performs the cancellation processing with the cancellation data CD12 at the cancellation timing CT2. Consequently, with the cancellation processing in the cancellation unit 123, the messages M11 and M12 are canceled from the demodulation-target data (FIG. 8) that includes the messages M11, M12, M21, and M22. Consequently, as illustrated in FIG. 10, only the messages M21 and M22 remain in the demodulation-target data that undergoes the cancellation processing in the cancellation unit 123. The cancellation unit 123 updates the demodulation-target data (FIG. 8) that is stored in the data storage unit 113, with the demodulation-target data that undergoes the cancellation processing, more precisely, with the demodulation-target data (FIG. 10) that includes the messages M21 and M22. Consequently, only the message M21 and the message M22 are included in next-time demodulation-target data.

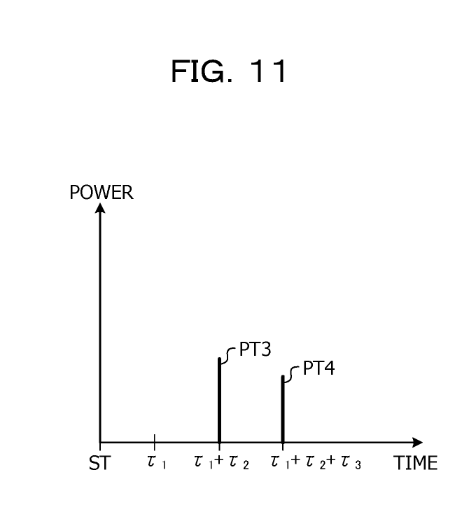

The timing control unit 125 updates the PA timing that is stored in the preamble timing storage unit 109, using the cancellation timings CT1 and CT2 that are cancellation processing targets. For example, the timing control unit 125 deletes PA timings that correspond to the cancellation timings CT1 and CT2, among the PA timings PT1, PT2, PT3, and PT4. The cancellation timing CT1, like the PA timing PT1, is a timing that is not delayed from the reference timing ST, and the cancellation timing CT2, like the PA timing PT2, is a timing that is delayed by as much as τ₁ from the reference timing ST. More precisely, the PA timing PT1 corresponds to the cancellation timing CT1, and the PA timing PT2 corresponds to the cancellation timing CT2. Accordingly, the timing control unit 125 deletes the PA timings PT1 and PT2, from the PA timings PT1, PT2, PT3, and PT4 that are stored in the preamble timing storage unit 109. With the deletion of the PA timings PT1 and PT2, only the PA timings PT3 and PT4 remain in the preamble timing storage unit 109, as illustrated in FIG. 11.

Accordingly, the timing control unit 125 selects the PA timing PT3 that is a PA timing at which the power is at a maximum, from among the PA timing PT3 and PT4 that remains in the preamble timing storage unit 109. Then, the timing control unit 125 outputs an instruction that performs the demodulation at the PA timing PT3, to the demodulation decoding unit 117. According to the demodulation that performs the demodulation, the demodulation decoding unit 117 demodulates the demodulation-target data that is stored in the data storage unit 113, more precisely, the demodulation-target data (FIG. 10) that includes the messages M21 and M22, at the PA timing PT3 that is set as the modulation timing. More precisely, the demodulation decoding unit 117 performs demodulation processing using the PA timing PT3 as the PA timing of the UE #2 that transmits the messages M21 and M22. At this time, the demodulation decoding unit 117 demodulates the demodulation-target data using the channel estimation value h₃. With the demodulation at the PA timing PT3, the post-demodulation message M21 is obtained. The demodulation decoding unit 117 decodes the post-modulation message M21. The demodulation decoding unit 117 demasks the CRC bit, which is included in the post-decoding message M21, with TC-RNTI=01, and thus performs the CRC. Because the CRC bit of the message M21, as described above, is demasked with TC-RNTI=01 by the UE #2, the demodulation decoding unit 117 succeeds in the CRC that results from the demasking that uses TC-RNTI=01. Consequently, the demodulation decoding unit 117 succeeds in decoding the message M21, and detects UE-ID=222 from a data portion of the message M21. The demodulation decoding unit 117 outputs the post-coding message M21 to the replica generation unit 119, and outputs UE-ID=222, which is detected, to the message processing unit 127.

Subsequently, when UE-ID=222 is input from the demodulation decoding unit 117, the message processing unit 127 generates the contention resolution that includes UE-ID=222 and the C-RNTI in the data portion thereof. In the generation of the contention resolution, the message processing unit 127 allocates, for example, C-RNTI=02, to UE-ID=222. The message processing unit 127 attaches the CRC bit that is masked with TC-RNTI=01, to the data portion of the contention resolution. Then, the message processing unit 127 codes the contention resolution that includes the data portion that includes UE-ID=222 and C-RNTI=02, and the CRC bit which is masked with TC-RNTI=01. The post-coding contention resolution is transmitted, as the Msg 4 in the RA procedure, by the wireless transmission unit 129, through the antenna 101. Furthermore, the message processing unit 127 outputs C-RNTI=02, which is allocated, to the communication processing unit 131.

The RA control unit 211 of the UE #2 demodulates and codes the contention resolution. The RA control unit 211 of the UE #2 demasks the CRC bit, which is included in the post-decoding contention resolution, with TC-RNTI=01, and thus performs the CRC. Because the CRC bit of the contention resolution, as described above, is masked with TC-RNTI=01 by the base station 10, the RA control unit 211 of the UE #2 succeeds in the CRC that results from the demasking that uses TC-RNTI=01. Consequently, the RA control unit 211 of the UE #2 succeeds in the decoding of the contention resolution, and detects UE-ID=222 and C-RNTI=02 from the data portion of the contention resolution. Because the UE-ID that is acquired from the contention resolution and the UE-ID that is included in the Msg 3 are consistent with each other, that is, UE-ID=222, the RA control unit 211 of the UE #2 determines that the success in the RA takes place. Furthermore, because the success in the RA takes place, the RA control unit 211 of the UE #2 outputs C-RNTI=02, which is included in the contention resolution, to the communication processing unit 213.

Then, the communication processing unit 213 of the UE #2 starts communication of the user data that uses C-RNTI=02 between the UE #2 and the base station 10. In the base station 10, the communication processing unit 131 starts the communication of the user data that uses C-RNTI=02, between the base station 10 and the UE #2. The communication processing unit 213 of the UE #2 attaches the CRC bit, which is masked with C-RNTI=02, to the user data that is a transmission target, codes the user data that undergoes the attaching of the CRC bit, and outputs the post-coding user data to the wireless transmission unit 205. In contrast, the communication processing unit 131 of the base station 10 demodulates and decodes the user data and demasks the CRC bit, which is attached to the post-coding user data, with C-RNTI=02, and thus performs the CRC. The communication processing unit 131 of the base station 10 attaches the CRC bit, which is masked with C-RNTI=02, to the user data that is a transmission target, codes the user data that undergoes the attaching of the CRC bit, and outputs the post-coding user data to the wireless transmission unit 129. In contrast, the communication processing unit 213 of the UE #2 demodulates and decodes the user data and demasks the CRC bit, which is attached to the post-coding user data, with C-RNTI=02, and thus performs the CRC.

On the other hand, in the base station 10, the replica generation unit 119 codes and modulates the post-coding message M21, generates a replica R21 of the message M21, and outputs the generated replica R21 to the path timing detection unit 121 and the cancellation unit 123.

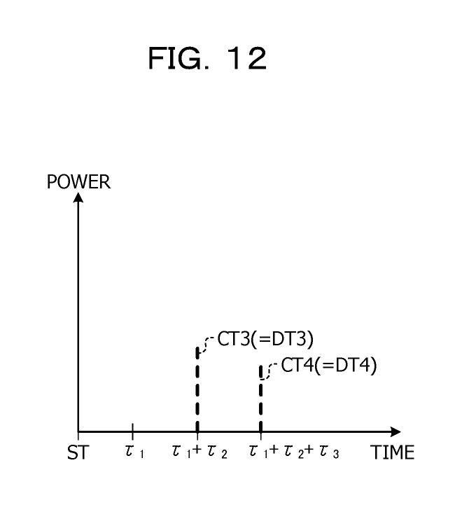

Subsequently, the path timing detection unit 121 calculates a value of correlation between the demodulation-target data that is stored in the data storage unit 113, more precisely, the demodulation-target data (FIG. 10) that includes the messages M21, and M22, and the replica R21. The replica R21 is a replica of the message M21. Furthermore, contents of the message M21 and contents of the message M22 are the same. Consequently, the value of correlation between the demodulation-target data (FIG. 10) that includes the messages M21 and M22 and the replica R21 is equal to or greater than a threshold at the head timing DT3 of the message M21 and the head timing DT4 of the message M22. Accordingly, the path timing detection unit 121, as illustrated in FIG. 12, detects the head timing DT3 as the cancellation timing CT3, and detects the head timing DT4 as the cancellation timing CT4. The path timing detection unit 121 outputs the detected cancellation timings CT3 and CT4 to the cancellation unit 123.

Subsequently, the cancellation unit 123 generates cancellation data CD21 by multiplying the replica R21 by the channel estimation value h₃, and generates cancellation data CD22 by multiplying the replica R21 by the channel estimation value h₄. Then, the cancellation unit 123 cancels the cancellation data CD21 and the cancellation data CD22 from the demodulation-target data that is stored in the data storage unit 113, more precisely, from the demodulation-target data (FIG. 10) that includes the messages M21 and M22. The cancellation unit 123 performs the cancellation processing with the cancellation data CD21 at the cancellation timing CT3, and performs the cancellation processing with the cancellation data CD22 at the cancellation timing CT4. Consequently, with the cancellation processing in the cancellation unit 123, the messages M21 and M22 are canceled from the demodulation-target data (FIG. 10) that includes the messages M21 and M22, the next-time demodulation target data is no longer present. Accordingly, the cancellation unit 123 deletes the demodulation-target data (FIG. 10) that is stored in the data storage unit 113.

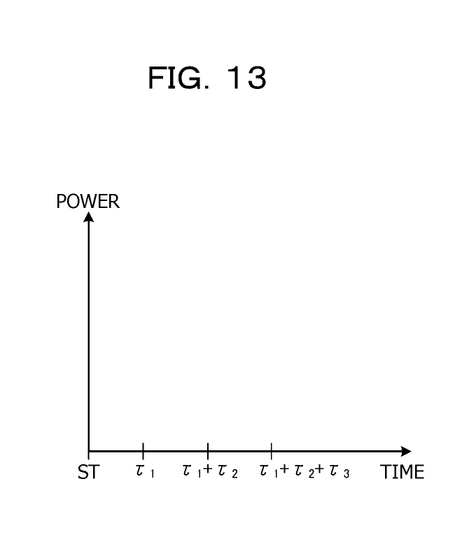

The timing control unit 125 updates the PA timing that is stored in the preamble timing storage unit 109, using the cancellation timings CT3 and CT4 that are cancellation processing targets. The cancellation timing CT3, like the PA timing PT3, is a timing that is delayed by as much as τ₁+τ₂ from the reference timing ST. Furthermore, the cancellation timing CT4, like the PA timing PT4, is a timing that is delayed by as much as τ₁+τ₂+T3 from the reference timing ST. More precisely, the PA timing PT3 corresponds to the cancellation timing CT3, and the PA timing PT4 corresponds to the cancellation timing CT4. Accordingly, for example, the timing control unit 125 deletes the PA timing PT3 that corresponds to the cancellation timing CT3, and the PA timing PT4 that corresponds to the cancellation timing CT4. With the deletion of the PA timings PT3 and PT4, the PA timing that is stored in the preamble timing storage unit 109 is no longer present as illustrated in FIG. 13.

More precisely, when all the PA timings PT1 to PT4 that are initially stored in the preamble timing storage unit 109 are used as the cancellation timing, the PA timing that is stored in the preamble timing storage unit 109 is no longer present. The cancellation timing CT1 is consistent with the head timing DT1 (more precisely, the path timing of the message M11), and the cancellation timing CT2 is consistent with the head timing DT2 (more precisely, the path timing of the message M12). Furthermore, the cancellation timing CT3 is consistent with the head timing DT3 (more precisely, the path timing of the message M21), and the cancellation timing CT4 is consistent with the head timing DT4 (more precisely, the path timing of the message M22). Furthermore, the head timings DT1, DT2, DT3, and DT4 (FIG. 8) correspond to the PA timings PT1, PT2, PT3, and PT4 (FIG. 7), respectively, on a one-to-one basis. Consequently, when all multiple PA timings that are detected by the preamble detection unit 107 correspond to a “first PA timing” or a “second PA timing” that follows, the PA timing that is stored in the preamble timing storage unit 109 is no longer present. The “first PA timing” is a PA timing that corresponds to the path timing of the Msg 3 from the UE #1. Furthermore, the “second PA timing” is a PA timing of the UE #2.

Because the PA timing that is stored in the preamble timing storage unit 109 is no longer present, the timing control unit 125 outputs an instruction that ends the demodulation, to the demodulation decoding unit 117. The demodulation decoding unit 117 ends the demodulation and the coding of the demodulation-target data according to the instruction that ends the demodulation. More precisely, when the PA timing that is stored in the preamble timing storage unit 109 is no longer present, the demodulation decoding unit 117 ends the demodulation and the coding of the demodulation-target data. Because with the ending of the demodulation and the decoding in the demodulation decoding unit 117 an output from the demodulation decoding unit 117 is no longer present, the generation of the replica in the replica generation unit 119, the detection of the cancellation timing in the path timing detection unit 121, and the cancellation processing in the cancellation unit 123 end as well.

<Example of Processing by the Base Station>

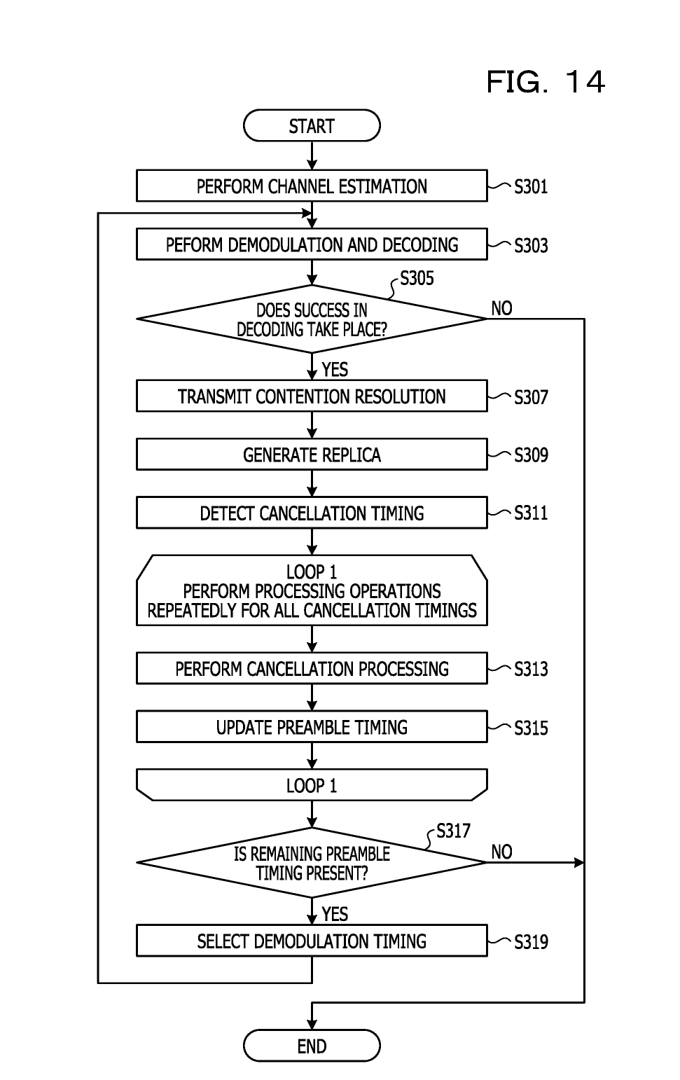

FIG. 14 is a flowchart that serves to describe an example of processing by the base station according to the first embodiment. The flowchart that is illustrated in FIG. 14, for example, starts when the Msg 3 acquisition unit 111 acquires the Msg 3.

In FIG. 14, in Step S301, the channel estimation unit 115 performs channel estimation of the acquired Msg 3. The channel estimation unit 115 calculates a channel estimation value of the path through which the Msg 3 is transmitted, using the payload that is attached to the Msg 3.

Subsequently, in Step S303, according to the demodulation timing of which an indication comes from the timing control unit 125, the demodulation decoding unit 117 demodulates the Msg 3 that is stored in the data storage unit 113, more precisely, the demodulation-target data, and decodes the post-demodulation data.

When the demodulation decoding unit 117 succeeds in the decoding in Step S303 (Yes in Step S305), the processing proceeds to Step S307, and when the demodulation decoding unit 117 fails in the decoding in Step S303 (No in Step S305), the processing ends.

In Step S307, the message processing unit 127 generates the contention resolution, and the wireless transmission unit 129 transmits the generated contention resolution.

Subsequently in Step S309, the replica generation unit 119 decodes and modulates the post-demodulation Msg 3 and generates the replica of the Msg 3.

Subsequently, in Step S311, the path timing detection unit 121 detects the cancellation timing.

Subsequently, under a condition of a loop 1, processing operations in Steps S313 and S315 are repeatedly performed. That is, for all cancellation timings that are detected in Step S311, the processing operations in Step S313 and S315 are repeatedly performed.

In Step S313, the cancellation unit 123 multiplies the replica by the channel estimation value, and thus generates the cancellation data, and cancels the cancellation data from the demodulation-target data that is stored in the data storage unit 113.

Subsequently, in Step S315, based on the cancellation timing that is a cancellation target in the cancellation unit 123, the timing control unit 125 updates the PA timing that is stored in the preamble timing storage unit 109. For example, the timing control unit 125 deletes the PA timing that corresponds to the cancellation timing that is the cancellation target, from the PA timing that is stored in the preamble timing storage unit 109.

After the repetition processing in the loop 1 ends, in Step S317, the timing control unit 125 determines whether or not the remaining PA timing is present in the preamble timing storage unit 109. When the remaining PA timing is present in the preamble timing storage unit 109 (Yes in Step S317), the processing proceeds to Step S319. On the other hand, when the remaining PA timing is no longer present in the preamble timing storage unit 109 (No in Step S317), the processing ends.

In Step S319, the timing control unit 125 selects the demodulation timing in the demodulation decoding unit 117, from among the PA timing that is stored in the preamble timing storage unit 109. For example, after the PA timing is updated in Step S315, when multiple remaining PA timings are present in the preamble timing storage unit 109, the timing control unit 125 selects the demodulation timing as follows. That is, the timing control unit 125 selects the PA timing at which the power is at a maximum, as the demodulation timing that is used for next modulation, from among the multiple remaining PA timings. Then, the timing control unit 125 instructs the demodulation decoding unit 117 on the selected demodulation timing. After the processing in Step S319, the processing returns to Step S303.

<Example of Processing by the Communication System>

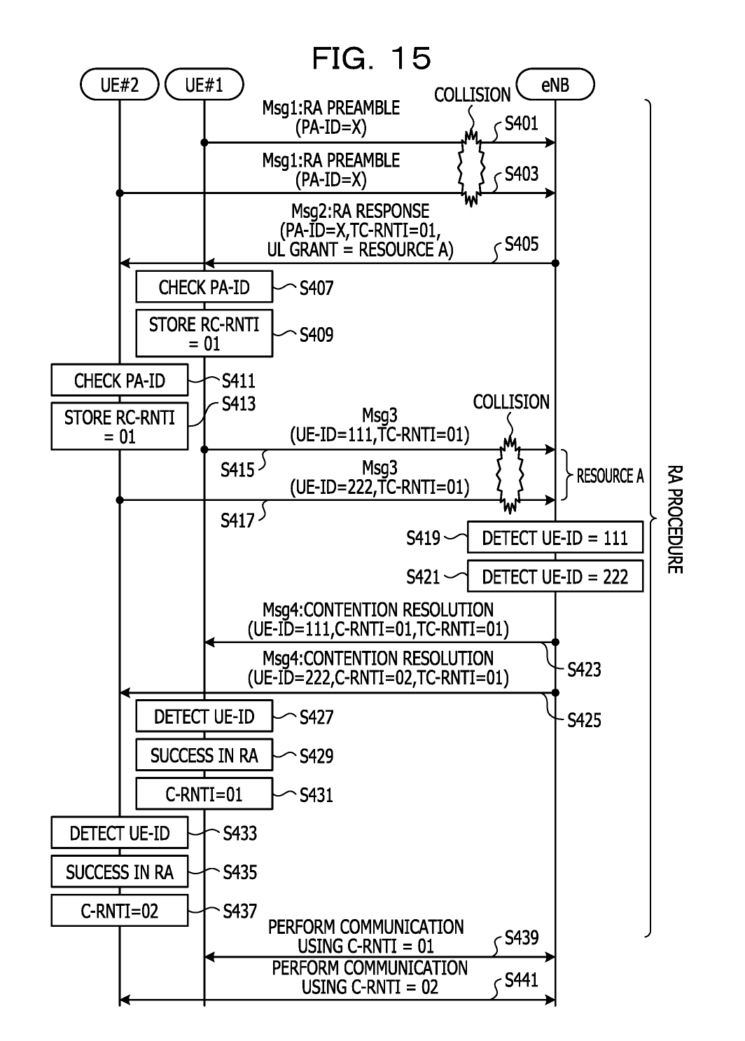

FIG. 15 is a diagram illustrating one example of a sequence of processing by the communication system according to the first embodiment. FIG. 15 illustrates one example of a RA procedure in a case where the UE #1 and the UE #2 transmit the same RA preamble to each other on the same resource.

In FIG. 15, in Step S401, first, the UE #1 randomly selects one PA-ID from among multiple PA-IDs that are prepared in advance and that are different from one another, and transmits a RA preamble that includes the selected PA-ID, as the Msg 1 to the eNB. In Step S401, the UE #1 is assumed to select PA-ID=X.

On the other hand, in Step S403, the UE #2 selects one PA-ID from among the multiple PA-IDs that are prepared in advance and that are different from one another, and transmits the RA preamble that includes the selected PA-ID, as the Msg 1 to the eNB. In Step S403, the UE #2 is assumed to select PA-ID=X. Furthermore, in Step S403, the UE #2 is assumed to transmit the RA preamble on the same resource as the resource on which the UE #1 transmits the RA preamble. More precisely, the UE #2 is assumed to transmit the same RA preamble as the RA preamble that is transmitted by the UE #1, using the same resource as with the UE #1.

Consequently, in the eNB, the RA preamble that is received from the UE #1 and the RA preamble that is received from the UE #2 collide with each other, and the reception of the two RA preamble is measured as multiple-times reception of the same RA preamble.

Accordingly, in Step S405, the eNB that detects the RA preamble which included PA-ID=X transmits the RA response to the RA preamble, as the Msg 2. At this point, the RA response the PA-ID, the TC-RNTI, and the UL grant that are included in the RA preamble. The uplink resource that is indicated by the UL grant is stipulated with time and a frequency. For example, the eNB allocates TC-RNTI=01 and UL grant=resource A to PA-ID=X. Consequently, for example, the eNB that detects the RA preamble that includes PA-ID=X transmits the RA response that includes PA-ID=X, TC-RNTI=01, and UL grant=resource A, as the Msg 2. More precisely, PA-ID=X, TC-RNTI=01, and UL grant=resource A correspond to one another. The RA response that is transmitted from eNB in Step S405 is received in the UE #1 and the UE #2.

In Step S407, the UE #1 that receives the RA response checks whether or not PA-ID=X that is selected in Step S401 is included in the received RA response.

In Step S409, because PA-ID=X is included in the received RA response, the UE #1 stores TC-RNTI=01 that is included in the RA response.

In Step S411, the UE #2 that receives the RA response checks whether or not PA-ID=X that is selected in Step S403 is included in the received RA response.

In Step S413, because PA-ID=X is included in the received RA response, the UE #2 stores TC-RNTI=01 that is included in the RA response.

In Step S415, because PA-ID=X is included in the received RA response, the UE #1 transmits the Msg 3 to the eNB using the resource A. The UE-ID of the UE #1 (for example, UE-ID=111) and the CRC bit that is masked with TC-RNTI=01 are included in the Msg 3 that is transmitted from the UE #1.

In Step S417, because PA-ID=X is included in the received RA response, the UE #2 transmits the Msg 3 to the eNB using the resource A. The UE-ID of the UE #2 (for example, UE-ID=222) and the CRC bit that is masked with TC-RNTI=01 are included in the Msg 3 that is transmitted from the UE #2.

In Steps S419 and S421, the eNB attempts to receive the Msg 3 on the resource A that is allocated in Step S405. Because the uplink resource that is allocated to the eNB and the TC-RNTI that is allocated to the eNB correspond to each other, on a one-to-one basis, the eNB decodes the Msg 3 that is received on the resource A, using TC-RNTI=01 that corresponds to the resource A.

At this point, because the Msg 3 from the UE #1 and the Msg 3 from the UE #2 are both transmitted using the resource A, that is, because the Msg 3 from the UE #1 and the Msg 3 from the UE #2 are transmitted on the same resource, the Msg 3 from the UE #1 and the Msg 3 from the UE #2 reach the eNB in a temporarily overlapping manner. Consequently, in the eNB, the Msg 3 from the UE #1 and the Msg 3 from the UE #2 collide with each other. In this manner, in a case where the Msg 3 from the UE #1 and the Msg 3 from the UE #2 collide with each other in a temporarily overlapping manner, the Msg 3 from the UE #2 interferes with the Msg 3 from the UE #1, and the Msg 3 from the UE #1 interferes with the Msg 3 from the UE #2. For this reason, while the Msg 3 from the UE #1 and the Msg 3 from the UE #2 temporarily overlap each other in the eNB, it is possible for the eNB to detect only the Msg 3 from the UE that is in a favorable channel environment, among the UE #1 and the UE #2. For example, in a case where the UE #1 is in a favorable channel environment and the UE #2 is in a poor channel environment, in the eNB, while the Msg 3 from the UE #1 and the Msg 3 from the UE #2 temporarily overlap each other, it is possible to detect only the Msg 3 from the UE #1. At this point, it is assumed that the UE #1 is in a favorable channel environment and that UE #2 is in a poor channel environment. Consequently, in Step S419, the eNB succeeds in decoding only the Msg 3 from the UE #1, among the Msg 3 from the UE #1 and the Msg 3 from the UE #2, which are both received on the same resource A, and detects UE-ID=111 that is included in the data portion of the Msg 3.

On the other hand, in Step S421, the eNB performs processing operations in Steps S301 to S319 according to the flowchart described above, which is illustrated in FIG. 14. That is, in Step S421, the eNB operates as described in the operational example described above. With the processing operations in Step S301 and S319, the eNB not only succeeds in decoding the Msg 3 from the UE #2, but also detects UE-ID=222 that is included in the data portion of the Msg 3.

In Step S423, the eNB that detects UE-ID=111 in Step S419 allocates C-RNTI=01 to UE-ID=111. Then, the eNB transmits the contention resolution that includes UE-ID=111, C-RNTI=01, and the CRC bit that is masked with TC-RNTI=01.

In Step S425, the eNB that detects UE-ID=222 in Step S421 allocates C-RNTI=02 to UE-ID=222. Then, the eNB transmits the contention resolution that includes UE-ID=222, C-RNTI=02, and the CRC bit that is masked with TC-RNTI=01.

In Step S427, the UE #1 decodes the received contention resolution using TC-RNTI=01 that is stored in Step S409. UE-ID=111, C-RNTI=01, and the CRC bit that is masked with TC-RNTI=01 are included in the contention resolution that is transmitted from the eNB in Step S423. Consequently, the UE #1 that performs the decoding using TC-RNTI=01 succeeds in decoding the contention resolution that is transmitted from eNB in Step S423, and detects UE-ID=111 that is included in the data portion of the contention resolution.

In Step S429, the UE #1 determines whether or not the UE-ID that is detected in Step S427 is the UE-ID of the UE #1 itself. Because UE-ID=111 that is detected in Step S427 is the UE-ID of the UE #1, the UE #1 determines that the success in the RA takes place.

In Step S431, the UE #1 that determines that the success in the RA takes place acquires C-RNTI=01 from the contention resolution, the decoding of which is successful in Step S427.

On the other hand, in Step S433, the UE #2 decodes the received contention resolution using TC-RNTI=01 that is stored in Step S413. UE-ID=222, C-RNTI=02, and the CRC bit that is masked with TC-RNTI=01 are included in the contention resolution that is transmitted from the eNB in Step S425. Consequently, the UE #2 that performs the decoding using TC-RNTI=01 succeeds in decoding the contention resolution that is transmitted from eNB in Step S425, and detects UE-ID=222 that is included in the data portion of the contention resolution.

In Step S435, the UE #2 determines whether or not the UE-ID that is detected in Step S433 is the UE-ID of the UE #2 itself. Because UE-ID=222 that is detected in Step S433 is the UE-ID of the UE #2, the UE #2 determines that the success in the RA takes place.

In Step S437, the UE #2 that determines that the success in the RA takes place acquires C-RNTI=02 from the contention resolution, the decoding of which is successful in Step S433.

In Step S439, the UE #1 that determines that the success in the RA takes place starts the communication of the user data with the eNB, using C-RNTI=01 that is acquired in Step S431.

In Step S441, the UE #2 that determines that the success in the RA takes place starts the communication of the user data with the eNB, using C-RNTI=02 that is acquired in Step S437.

In this manner, as a result of the UE #1 and the UE #2 transmitting the same RA preamble using the same resource, even in a case where a collision between the Msg 3 from the UE #1 and the Msg 3 from the UE #2 occurs, the eNB can succeed in decoding both of the Msg 3 from the UE #1 and the Msg 3 from the UE #2. For this reason, the eNB can transmit the contention resolution that includes UE-ID=111 which is acquired from the Msg 3 from the UE #1 and the contention resolution that includes UE-ID=222 which is acquired from the Msg 3 from the UE #2. Consequently, the UE #1 that detects UE-ID=111 that is the UE-ID of the UE #1 itself from the received contention resolution succeeds in the RA. Furthermore, the UE #2 that detects UE-ID=222 that is the UE-ID of the UE #2 itself from the received contention resolution succeeds in the RA as well. More precisely, even in a case where the collision of the Msg 3 from the UE #1 and the Msg 3 from the UE #2 occurs, both of the UE #1 And the UE #2 can succeed in the RA. Consequently, according to the first embodiment, an improvement in the rate of the success in the RA can be achieved.

As described above, according to the first embodiment, the base station 10 includes a preamble detection unit 107, a path timing detection unit 121, a cancellation unit 123, and a demodulation decoding unit 117. The preamble detection unit 107 detects the PA timing from the RA preamble that is received in the RA procedure. The path timing detection unit 121 detects the path timing of each Msg 3 that is included in the reception Msg 3, from the reception Msg 3 that is received after the RA preamble is received in the RA procedure. Based on the path timing of each Msg 3 that is detected by the path timing detection unit 121, the cancellation unit 123 cancels each Msg 3 from the reception Msg 3. The demodulation decoding unit 117 obtains the messages M11 and M12 from the reception Msg 3 by demodulating the reception Msg 3. Furthermore, after the messages M11 and M12 are obtained, the demodulation decoding unit 117 demodulates the demodulation-target data that results after the messages M11 and M12 are cancelled by the cancellation unit 123 from the reception Msg 3, and thus obtains the messages M21 and M22 that are included in the reception Msg 3. Based on a desired PA timing, among the PA timings that are detected by the preamble detection unit 107, the demodulation decoding unit 117 demodulates the demodulation-target data that results after the messages M11 and M12 are cancelled from the reception Msg 3. The desired timing is a PA timing other than the PA timing that corresponds to the path timings of the messages M11 and M12, among the PA timings that are detected by the preamble detection unit 107. In the RA procedure, the Msg 3 is one example of data that is received after the base station 10 receives the RA preamble. Furthermore, the messages M11 and M12 are one example of a “first Msg 3” that is included in the reception Msg 3, and the messages M21 and M22 are one example of a “second Msg 3” that is included in the reception Msg 3.

By doing this, the demodulation-target data that results after the first Msg 3 is canceled from the reception Msg 3, more precisely, the demodulation-target data in which the first Msg 3 is not included, but in which the second Msg 3 is included, can be demodulated at the demodulation timing that is suitable for the second Msg 3. For this reason, even in a case where the first Msg 3 and the second Msg 3 are received on the same uplink resource, more precisely, even in a case where the first Msg 3 and the second Msg 3 collide with each other, in the base station 10, it is possible to succeed in decoding both of the first Msg 3 and the second Msg 3. Consequently, in the base station 10, it is possible to detect each UE-ID of the UE #1 and the UE #2 from the first Msg 3 and the second Msg 3 and thus notify the UE #1 and the UE #2 of each UE-ID. For this reason, both of the UE #1 and the UE #2 can be made to succeed in the RA. Consequently, according to the first embodiment, the improvement in the rate of the success in the RA can be achieved.

Furthermore, the path timing detection unit 121 calculates a value of correlation between the reception Msg 3 and a replica of the first Msg 3 based on the PA timing that is detected by the preamble detection unit 107, and thus detects a path timing of the first Msg 3.

By doing this, the detection of the path timing of the first Msg 3 can be performed with a high likelihood that the path timing of the first Msg 3 will be present. For this reason, an improvement in the precision with which the path timing of the first Msg 3 is detected can be achieved. Furthermore, an amount of processing in the detection of the path timing of the first Msg 3 can be reduced.

Furthermore, based on the PA timing at which the power is equal to or greater than a threshold, among the PA timings that are detected by the preamble detection unit 107, the path timing detection unit 121 calculates the value of the correlation between the reception Msg 3 and the replica of the first Msg 3.

By doing this, because a noisy-path timing at which the power is low is kept from being erroneously detected as the path timing of the first Msg 3, an improvement in the precision with which the cancellation processing of the first Msg 3 is performed can be achieved. Furthermore, with the improvement in the precision of the cancellation processing of the first Msg 3, an improvement in the precision with which the second Msg 3 is demodulated can be achieved.

Furthermore, the timing control unit 125 selects the PA timing at which the power is at a maximum, from among PA timings other than the PA timing that corresponds to the path timing of the first Msg 3, among the PA timings that are detected by the preamble detection unit 107. Then, based on the PA timing at which the power is at a maximum and that is selected, the demodulation decoding unit 117 demodulates the demodulation-target data that results after the first Msg 3 is cancelled from the reception Msg 3.

By doing this, because, among the second Msgs 3 that are received in the base station 10, the second Msg 3 can be demodulated that is transmitted through the path that is in the most favorable channel environment, the improvement in the precision with which the second Msg 3 is demodulated can be achieved.

Furthermore, when all the PA timings that are detected by the preamble detection unit 107 are used for the cancellation processing in the cancellation unit 123 and the demodulation processing in the demodulation decoding unit 117, the cancellation unit 123 ends the cancellation processing. Furthermore, when all the PA timings that are detected by the preamble detection unit 107 are used for the cancellation processing in the cancellation unit 123 and the demodulation processing in the demodulation decoding unit 117, the demodulation decoding unit 117 ends the demodulation processing.

By doing this, because unnecessary cancellation processing and unnecessary demodulation processing can be kept from being performed, power consumption by the base station 10 and the UE can be suppressed.

Furthermore, the base station 10 has the wireless transmission unit 129. After the second Msg 3 is obtained by the demodulation decoding unit 117, the wireless transmission unit 129 transmits the contention resolution including the C-RNTI that is allocated to the UE #2, in the RA procedure. The C-RNTI that is allocated to the UE #2 is different from the C-RNTI that is allocated to the UE #1. The contention resolution is one example of the data that includes the C-RNTI.

By doing this, in the base station 10, because it is possible to identify each UE using the C-RNTI, it is possible to perform the communication of the use data with both of the UE #1 and the UE #2.

Furthermore, the user terminal 20 has the wireless reception unit 209 and the communication processing unit 213. In the user terminal 20 as the UE #1, the wireless reception unit 209 receives the contention resolution that includes the C-RNTI which is allocated to the UE #1, from the base station 10 in the RA procedure, and the communication processing unit 213 communicates with the base station 10 using the C-RNTI that is allocated to the UE #1. In the user terminal 20 as the UE #2, the wireless reception unit 209 receives the contention resolution that includes the C-RNTI which is allocated to the UE #2, from the base station 10 in the RA procedure, and the communication processing unit 213 communicates with the base station 10 using the C-RNTI that is allocated to the UE #2.

By doing this, in each UE, because it is possible to identify the user data of each UE itself using the C-RNTI, it is possible to perform the communication of the user data with the base station 10.

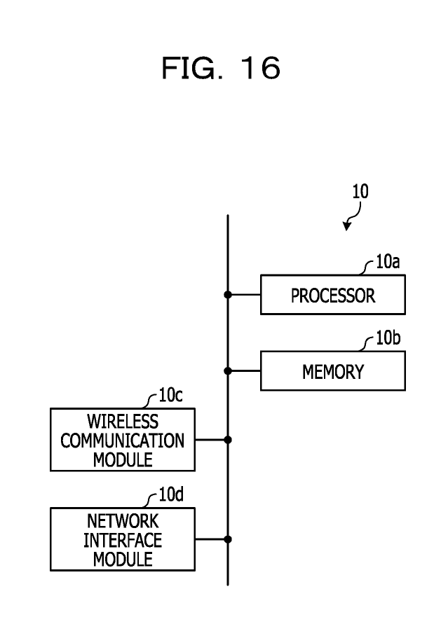

### OTHER EMBODIMENTS

[1] According to the first embodiment, the timing control unit 125 deletes the PA timing that corresponds to the cancellation timing, among the PA timings that are stored in the preamble timing storage unit 109. However, the timing control unit 125 may cancel the PA timing that corresponds to the cancellation timing, instead of deleting the PA timing. In a case where the PA timing that corresponds to the cancellation timing is cancelled, the timing control unit 125 may select the next-time demodulation timing from among the PA timings that are not masked.

[2] According to the first embodiment, the case where the Msgs 3 that are transmitted from the two items of UE, that is, the UE #1 and the UE #2, is described above. In a case where the Msgs 3 that are transmitted from three or more items of UE collide with one another, the same cancellation processing and demodulation processing as those described above may be repeated until the PA timing that is stored in the preamble timing storage unit 109 is no longer present. Thus, the Msg 3 that is transmitted from each of the three or more items of UE can be demodulated.

[3] According to the first embodiment, the case where the demodulation decoding unit 117 performs both of the demodulation and the decoding is described above. However, the demodulation decoding unit 117 may be divided into a demodulation unit and a decoding unit. The demodulation unit may perform the demodulation described above, and the decoding unit may perform the decoding described above.

[4] The base station 10 can be realized with following hardware configuration. FIG. 16 is a diagram illustrating an example of a hardware configuration of the base station. As illustrated in FIG. 16, as hardware constituent elements, the base station 10 has a processor 10a, a memory 10b, a wireless communication module 10c, and a network interface module 10d. As one example of the processor 10a, a central processing unit (CPU), a digital signal processor (DSP), a field programmable gate array (FPGA), and the like are considered. Furthermore, the base station 10 may have a large scale integrated circuit (LSI) that includes the processor 10a and a peripheral circuit. As one example of the memory 10b, a RAM, such as an SDRAM, a ROM, a flash memory, or like is considered.

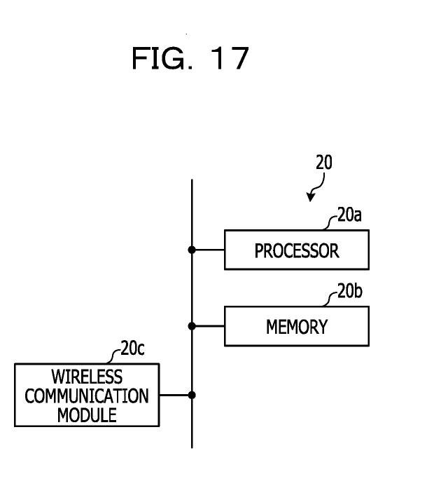

The antenna 101, the wireless reception unit 103, and the wireless transmission unit 129 are realized as the wireless communication module 10c. The preamble acquisition unit 105, the preamble detection unit 107, the Msg 3 acquisition unit 111, the channel estimation unit 115, the demodulation decoding unit 117, and the replica generation unit 119 are realized as the processor 10a. Furthermore, the path timing detection unit 121, the cancellation unit 123, the timing control unit 125, the message processing unit 127, and the communication processing unit 131 are realized as the processor 10a. The preamble timing storage unit 109 and the data storage unit 113 is realized as the memory 10b.

[5] The user terminal 20 can realize with the following hardware configuration. FIG. 17 is a diagram illustrating an example of a hardware configuration of the user terminal. As illustrated in FIG. 17, as hardware constituent elements, the user terminal 20 has a processor 20a, a memory 20b, and a wireless communication module 20c. As one example of the processor 20a, a CPU, a DSP, an FPGA, or the like is considered. Furthermore, the user terminal 20 may have an LSI that includes the processor 20a and a peripheral circuit. As one example of the memory 20b, a RAM, such as an SDRAM, a ROM, a flash memory, or like is considered.

The antenna 207, the wireless transmission unit 205, and the wireless reception unit 209 are realized as the wireless communication module 20c. The preamble processing unit 201, the message processing unit 203, the RA control unit 211, and the communication processing unit 213 are realized as the processor 20a.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A base station comprising:
a memory; and
a processor coupled to the memory and configured to:
detect a plurality of preamble timings in a received wireless signal, the plurality of preamble timings including one or more first preamble timings and one or more second preamble timings, the one or more first preamble timings being one or more timings in which a first random access preamble transmitted from a first terminal is received by the base station via one or more first path, the one or more second preamble timings being one or more timings in which a second random access preamble transmitted from a second terminal is received by the base station via one or more second path, the first random access preamble and the second random access preamble being transmitted using a same resource,
decode a message that is one of a first message and a second message in another received wireless signal, the first message being transmitted from the first terminal and being associated with the first random access preamble, the second message being transmitted from the second terminal and being associated with the second random access preamble, the first message and the second message being transmitting using another same resource,
generate a replica of the decoded message,
specify a plurality of message timings in the another received wireless signal that correspond to the plurality of preamble timings in the received wireless signal,
specify one or more cancel timings from among the plurality of message timings in the another received wireless signal, the one or more cancel timings in the another received wireless signal corresponding to the one or more first preamble timings in the received wireless signal when the decoded message is the first message transmitted from the first terminal, the one or more cancel timings in the another received wireless signal corresponding to the one or more second preamble timings in the received wireless signal when the decoded message is the second message transmitted from the second terminal,
generate a specified signal by cancelling the generated replica from the another received wireless signal in the one or more cancel timings, and
decode the other of the first message and the second message that has not been decoded in the another received wireless signal based on the specified signal and one or more specified timings that are the plurality of message timings other than the one or more cancel timings.

2. The base station according to claim 1, wherein
the one or more cancel timings in the another received wireless signal are specified by calculating a plurality of correlation values of the another received wireless signal in the plurality of message timings.

3. The base station according to claim 2, wherein
the one or more cancel timings are the plurality of message timings corresponding to the plurality of correlation values that are greater than a first threshold, and
the one or more specified timings are the plurality of message timings corresponding to the plurality of correlation values that are equal to or less than the first threshold.

4. The base station according to claim 2, wherein
the plurality of correlation values that corresponds to received powers in the plurality of preamble timings, being greater than a second threshold, are calculated.

5. The base station according to claim 1, wherein
the other of the first message and the second message is decoded based on a specified message timing in the plurality of message timings other than the one or more cancel timings, the specified message timing corresponding to a preamble timing in which a received power of a preamble is greatest in the plurality of preamble timings.

6. The base station according to claim 1, wherein
when all of the plurality of message timings are used for cancelling the generated replica or decoding the other of the first message and the second message, the cancelling and the decoding end.

7. The base station according to claim 1, wherein
the processor is further configured to:
detect a first identifier of the first terminal and a second identifier of the second terminal, in the first message and the second message that have been decoded respectively, and
transmit a first response message including the first identifier and a second response message including the second identifier respectively.

8. A wireless communication system comprising:
a first terminal;
a second terminal; and
a base station configured to:
detect a plurality of preamble timings in a received wireless signal, the plurality of preamble timings including one or more first preamble timings and one or more second preamble timings, the one or more first preamble timings being one or more timings in which a first random access preamble transmitted from the first terminal is received by the base station via one or more first path, the one or more second preamble timings being one or more timings in which a second random access preamble transmitted from the second terminal is received by the base station via one or more second path, the first random access preamble and the second random access preamble being transmitted using a same resource,
decode a message that is one of a first message and a second message in another received wireless signal, the first message being transmitted from the first terminal and being associated with the first random access preamble, the second message being transmitted from the second terminal and being associated with the second random access preamble, the first message and the second message being transmitting using another same resource,
generate a replica of the decoded message,
specify a plurality of message timings in the another received wireless signal that correspond to the plurality of preamble timings in the received wireless signal,
specify one or more cancel timings from among the plurality of message timings in the another received wireless signal, the one or more cancel timings in the another received wireless signal corresponding to the one or more first preamble timings in the received wireless signal when the decoded message is the first message transmitted from the first terminal, the one or more cancel timings in the another received wireless signal corresponding to the one or more second preamble timings in the received wireless signal when the decoded message is the second message transmitted from the second terminal,
generate a specified signal by cancelling the generated replica from the another received wireless signal in the one or more cancel timings, and
decode the other of the first message and the second message that has not been decoded in the another received wireless signal based on the specified signal and one or more specified timings that are the plurality of message timings other than the one or more cancel timings.

9. A wireless communication method comprising:
detecting a plurality of preamble timings in a received wireless signal, the plurality of preamble timings including one or more first preamble timings and one or more second preamble timings, the one or more first preamble timings being one or more timings in which a first random access preamble transmitted from a first terminal is received by the base station via one or more first path, the one or more second preamble timings being one or more timings in which a second random access preamble transmitted from a second terminal is received by the base station via one or more second path, the first random access preamble and the second random access preamble being transmitted using a same resource;
decoding a message that is one of a first message and a second message in another received wireless signal, the first message being transmitted from the first terminal and being associated with the first random access preamble, the second message being transmitted from the second terminal and being associated with the second random access preamble, the first message and the second message being transmitting using another same resource;
generating a replica of the decoded message;
specifying a plurality of message timings in the another received wireless signal that correspond to the plurality of preamble timings in the received wireless signal;
specifying one or more cancel timings from among the plurality of message timings in the another received wireless signal, the one or more cancel timings in the another received wireless signal corresponding to the one or more first preamble timings in the received wireless signal when the decoded message is the first message transmitted from the first terminal, the one or more cancel timings in the another received wireless signal corresponding to the one or more second preamble timings in the received wireless signal when the decoded message is the second message transmitted from the second terminal;
generating a specified signal by cancelling the generated replica from the another received wireless signal in the one or more cancel timings; and
decoding the other of the first message and the second message that has not been decoded in the another received wireless signal based on the specified signal and one or more specified timings that are the plurality of message timings other than the one or more cancel timings.
